(19) United States
(12) Patent Application Publication
(10) Pub. No.: US 2014/0178921 A1
(43) Pub. Date: Jun. 26, 2014

(54) APPARATUS AND PROCESS FOR ISOLATING SPECIFIC PHYSICAL ITEMS WITHIN A SET OF PHYSICAL ITEMS

(71) Applicant: Zachary Schulz Apte, Berkeley, CA (US)

(72) Inventor: Zachary Schulz Apte, Berkeley, CA (US)

(73) Assignee: EVOLVEMOL, Inc., Berkeley, CA (US)

(21) Appl. No.: 14/003,202

(22) PCT Filed: Mar. 5, 2012
(86) PCT No.: PCT/US2012/027791

§ 371 Date: Nov. 8, 2013

Related U.S. Application Data
(60) Provisional application No. 61/449,099, filed on Mar. 4, 2011.

(51) Int. Cl. G01N 1/34

(52) U.S. Cl. CPC G01N 1/34
USPC 435/30; 435/309.1

(57) ABSTRACT

Embodiments described herein provide an improved process for enriching, identifying, searching, separating and/or isolating target cells within a sample cell mixture using iterative enrichment or progression of the target cell, as well as some related methods and apparatuses. Two embodiments are microfluidic devices with multiple chambers into which a populations of cells are iteratively divided until a cell producing a target molecule is identified. Another embodiment is a faster and more broadly applicable process for the isolation of molecule producing cells comprising a series of laboratory methods for iterative enrichment. Some embodiments are directed to the process of directed evolution of cells secreting a target molecule. Another embodiment comprises a process for fast the identification of chemicals with specific properties through testing of combinations of items.

This application claims the benefit of the following U.S. Provisional patent application which is incorporated by reference herein in its entirety for all purposes: U.S. Provisional Patent Application No. 61/449,099, filed Mar. 4, 2011, entitled “Apparatus and Process for the Isolation or Identification of Specific Physical Items within a Set of Physical Items.”

### TECHNICAL FIELD

The disclosed embodiments relate generally to processes of enriching, identifying, searching, separating, or isolating specific items within a set of items.

### BACKGROUND

Both science and industry spend a great deal of time and money attempting to find rare physical items within a huge set of items. Many fields, including chemistry, biology, public health and environmental science, are concerned with doing exactly this.

Currently most of these techniques revolve around one of two processes. One of the processes in general use is to test a representative sample of the set of items and extrapolate the results to the whole set. This method tends to be relatively fast but is limited, as it will miss extremely rare items and will not work in situations where a representative sample is imposable or undesirable. An alternate process in general use is to individually measure the properties of each item in the set. This process scales linearly with the size of the set, and is thus time consuming and expensive for very large sets of items.

### SUMMARY

The embodiments described herein overcome the limitations and disadvantages described above by providing methods, systems, and apparatuses for isolating a target cell from a plurality of sample cells.

The following presents a summary of the invention in order to provide a basic understanding of some of the aspects of the invention. This summary is not an extensive overview of the invention. It is not intended to identify key/critical elements of the invention or to delineate the scope of the invention. Its sole purpose is to present some of the concepts of the invention in a simplified form as a prelude to the more detailed description that is presented later.

In some embodiments, a looped microfluidic apparatus for the isolation of a target cell from a plurality of sample cells is provided. The microfluidic apparatus comprises a first cell input element such as a first cell input channel configured to receive a sample mixture comprising one or more sample cells including at least one target cell. It also comprises a flow splitter configured to divide the sample mixture into at least two subsample mixtures each comprising one or more sample cells. The microfluidic apparatus further comprises a plurality of second cell chambers. Each respective second cell chamber of the plurality of second cell chambers is configured to hold a respective subsample mixture. Each second cell chamber includes a second cell chamber testing element configured for use in testing the subsample mixture and a second cell chamber output valve configured to control flow of the one or more sample cells of the respective subsample mixture out of the second cell chamber. The microfluidic apparatus also comprises a second cell chamber output channel coupled to a second cell chamber output valve, a discard channel, and a backsorting channel. It comprises a discard channel configured to receive the one or more sample cells of a respective subsample mixture to flow there through when a discard criterion is met. The backsorting channel is coupled to the flow splitter and is configured to receive one or-more sample cells of a respective subsample mixture to be reflowed to the flow splitter for iterative dividing of the mixture and testing when a retention criterion is met. In some embodiments, some or all of the above described components are directly coupled to one another. In other embodiments, intervening components are used to couple the above described components to one another.

Some embodiments provide a microfluidic apparatus having a branched or tree structure for the isolation of a target cell from a plurality of sample cells. The microfluidic apparatus comprises a first cell chamber configured to hold a sample mixture including one or more sample cells including at least one target cell. The first cell chamber includes a first cell chamber testing element configured for use in testing the sample mixture and a first cell chamber output valve configured to control flow of the sample cells of the sample mixture out of the first cell chamber when the sample mixture is larger than a desired size. A first cell chamber output channel is coupled to the first cell chamber output valve and includes a first flow splitter for dividing the sample mixture into at least two subsample mixtures each comprising one or more sample cells. The microfluidic apparatus further comprises a plurality of second cell chambers. Each second cell chamber of the plurality of second cell chambers is configured to hold a respective subsample mixture. A respective second cell chamber includes a second cell chamber testing element configured for use in testing the subsample mixture. In some embodiments, testing element includes a second cell chamber testing channel configured to allow removal of a portion of the respective subsample mixture from the second cell chamber while retaining the one or more sample cells of the respective subsample mixture. The microfluidic apparatus further comprises a second cell chamber output valve configured to control flow of the one or more cells of the respective subsample mixture out of the second cell chamber. It also includes a second cell chamber output channel coupled to the second cell chamber output valve with a second flow splitter for dividing the subsample mixture into at least two sub-subsample mixtures each comprising one or more sample cells. The branched microfluidic apparatus also includes a plurality of third cell chambers. Each respective third cell chamber is configured to hold a respective sub-subsample mixture. Each third cell chamber further including a third cell chamber testing element configured for use in testing the sub-subsample mixture and a third cell chamber output valve configured to control flow of the one or more cells of the respective sub-subsample mixture out of the third cell chamber. In some embodiments, some or all of the above described components are directly coupled to one another. In other embodiments, intervening components are used to couple the above described components to one another.

Any of the cell chamber output valves of the microfluidic apparatuses described herein are each configured to allow their respective mixture to pass out of their respective cell chamber, which is done when their respective mixture contains a target cell. Furthermore, the first, second, and third (and any additional) cell chamber output valves of the branched microfluidic apparatus are configured to retain their respective mixture in their respective cell chamber, which is done when the target cell is not present in the respective mixture until the identification process is complete or the iterations are ended, at which point these valves are opened and the mixtures which do not contain the target cell are flowed of the apparatus. The respective second cell chamber output valves of the looped microfluidic apparatus are configured to control flow of the one or more sample cells of a respective subsample mixture into the discard channel when the discard criterion is met.

In some embodiments, a method of isolating a target component from a plurality of sample components is provided. The method is performed as follows. A sample mixture comprising one or more sample components including a target component is received. The sample components of the sample mixture are divided into at least two subsample mixtures each comprising one or more sample components. The at least two subsample mixtures are tested for the presence of a target component. A respective subsample mixture of the at least two subsample mixtures is discarded when a discard criterion is met. Furthermore, a respective subsample mixture of the at least two subsample mixtures is retained when a retention criterion is met. The dividing, testing, discarding, and retaining are iteratively performed until an isolation criterion is met.

Thus, these methods and apparatuses provide new, less cumbersome, more efficient ways to isolate a target component from a plurality of sample components. In some embodiments, methods, systems, and apparatuses provide new, less cumbersome, more efficient ways to isolate a target cell from a plurality of sample cells. These isolation methods, systems, and apparatuses are exponentially faster in isolating or sorting rare physical items than the prior art. Furthermore, they allow for more sensitive and versatile detection of the properties of the rare items.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 is a flowchart illustrating a general overview of a protocol for isolating a target cell according to some embodiments.

FIG. 2 is a flowchart describing a process to separate, identify, enrich, and isolate cells of interest in accordance with some embodiments.

FIG. 3 is a flowchart describing a process to perform directed evolution of molecule producing cells in accordance with another embodiment.

FIG. 4 is a flowchart illustrating a process to separate, identify, enrich, and isolate a chemical or a sample from a set of chemicals or samples in accordance with another embodiment.

FIG. 5 is a flowchart illustrating a process to separate, identify, enrich, and isolate an item from a group of items in accordance with another embodiment.

FIG. 6 is a schematic illustrating a microfluidic apparatus having a branched or tree structure.

FIG. 7 is a schematic illustrating one embodiment of the microfluidic cell chamber with the output valve closed.

FIG. 8 is a schematic illustrating one embodiment of the microfluidic cell chamber with the output valve open.

FIG. 9 is a schematic illustrating a microfluidic apparatus having a looped structure.

FIG. 10 is a schematic illustrating another microfluidic apparatus having looped structure.

FIG. 11 is a schematic illustrating one embodiment of a microfluidic cell backsorting chamber with an additional filtered outlet.

Like reference numerals refer to corresponding parts throughout the drawings.

### DESCRIPTION OF EMBODIMENTS

The embodiments described herein pertain to processes of one or more of the following procedures: enriching, dividing, identifying, testing, searching, separating, discarding and/or isolating specific items within a set of items. To do this, in some embodiments, a scheme of iterative investigation of the set of items is used to exclude or separate items from the set of items until only the target item remains. Items are excluded or separated from the set by splitting the set into at least two subsets and investigating each subset for the presence of the specific target items. Subsets lacking the target items are excluded or separated; subsets containing target items are retained. These steps are then iterated with the retained subsets of items until only the target items remain.

### I. INTRODUCTION

Reference will now be made in detail to embodiments, examples of which are illustrated in the accompanying drawings. In the following detailed description, numerous specific details are set forth in order to provide a thorough understanding of the present embodiments. However, it will be apparent to one of ordinary skill in the art that the present various embodiments may be practiced without these specific details. In other instances, well-known methods, procedures, components, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first element could be termed a second element, and, similarly, a second element could be termed a first element, without changing the meaning of the description, so long as all occurrences of the first element are renamed consistently and all occurrences of the second element are renamed consistently. The first element and the second element are both elements, but they are not the same element.

The terminology used in the description of the embodiments herein is for the purpose of describing particular embodiments only and is not intended to be limiting of the claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” as well as the terms “includes” and/or “including” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to,” depending on the context. Similarly, the phrase “if it is determined” or “if (a stated condition or event) is detected” may be construed to mean “upon determining” or “in response to determining” or “upon detecting (the stated condition or event)” or “in response to detecting (the stated condition or event),” depending on the context.

As used herein, a buffer is a specific liquid media with specific salt, mineral pH and other conditions to promote the survival of the cells. Some examples of buffers are Luria Bertani (LB) Miller broth for E. coli (this is 1% peptone, 0.5% yeast extract, 1% NaCl), DNAGro™, ProGro™, and SecPro™. As used herein, a target molecule is any type of molecule that can be secreted or emitted through some non-destructive mechanism from the cells. This includes proteins, enzymes, antibodies, lipids, small-molecules, DNA, and other organic and inorganic compounds. In some embodiments, the target molecule is a green fluorescent protein, a cellulose, an alcohol, a pharmaceutical, such as an antimicrobial agent, such as an antibiotic or an antiviral, and others. In some embodiments, the target molecule is a protein. In some embodiments, the target molecule is an enzyme. In some embodiments, the target molecule is an antibody. In some embodiments, the target molecule is a small molecule. In some embodiments, the target molecule is a small molecule pharmaceutical. In some embodiments, the small molecule has a molecular weight of from 10 to 700 daltons. In some embodiments, the small molecule has a molecular weight of from 100 daltons to 700 daltons, or from 100 daltons to 600 daltons, or from 100 daltons to 500 daltons, or from 100 daltons to 400 daltons, or from 200 daltons to 600 daltons, or from 300 daltons to 600 daltons, or from 300 daltons to 700 daltons. In some embodiments, the sample cell is a microorganism cell. In some embodiments, the sample cell is a bacterial cell. In some embodiments, the sample cell is Escherichia coli. In some embodiments, the sample cell is a yeast cell. In some embodiments, the sample cell is Saccharomyces cerevisiae. In some embodiments, the sample cell is a mammalian cell. In some embodiments, the sample cell is a HeLa cell.

The technical process of directed evolution can be thought of as having three stages: (a) in vitro diversity generation, (b) transformation and in vivo small molecule production, and (c) screening and selection.

Each of these steps have a number of approaches. Both (a) and (b) can now be tackled in a random (for example, error-prone Polymerase Chain Reaction hereinafter PCR, in-vitro recombination) or directed (for example, Multiplex Automated Genome Engineering, hereinafter MAGE, site-directed mutagenesis) fashion. This application focuses on some methods and apparatuses for improving (c).

One high-throughput technique that has been utilized for (c) is as a selection determining assay in the directed evolution of a cell producing a target molecule is a combination of Fluorescence-Activated Cell Sorting, hereinafter FACS, with a specifically engineered biosensor. Before any sorting or diversity generation is done the desired target to be selected is decided. A biosensor molecule that will fluoresce when bound to the desired target is engineered and expressed the population. Diversity is then generated, and the fluorescent cells are selected with FACS. However, these techniques most often do not report on the actual presence of a specific target molecule in the first step, but rather only report the activation of a biosensor indicating a change in a bulk property of the cytoplasm. When they do select for a specific target molecule this method still has the drawback of only selecting for the presence or absence of single molecule. Similar molecules will not activate the sensor and go undetected.

There are also two techniques which may be used for finding rare physical items within a huge set of items, both of which have drawbacks. These are explained in more detail below.

One process, which is sometimes used for testing for food contaminants, is to test a representative sample of the set of items and extrapolate the results to the whole set. This method tends to be relatively fast but is limited, as it will miss extremely rare items and will not work in situations where a representative sample is imposable or undesirable.

Generally food testing is conducted on a manufacturer-by-manufacturer basis. Individual batches of food from individual manufacturers are periodically tested for a variety of contaminants using techniques such as High Performance Liquid Chromatography-Mass Spectrometry hereinafter HPLC-MS, cell-culture and PCR. However, the majority of food being produced is not being tested—meaning that rare contamination events will often go undetected. Undetected contamination of food can lead to outbreaks of food-borne illnesses, loss of revenue and collateral discarding of uncontaminated products. With current methods the relative expense of batch by batch testing for all possible contaminants would be prohibitively time consuming and expensive.

Another process, which is used for high-throughput drug screening and biological cell sorting, is to individually measure the properties of each item in the set. This process scales linearly with the size of the set, and is thus time consuming and expensive method for very large sets of items.

High-throughput drug and chemical screening is an area where item-by-item testing is used extensively. In general, a very large set of drugs is chosen to be tested for a specific pharmacological activity. Each drug is then assayed individually for the required activity. These methods often use robotized sample handling and automated testing to perform as many tests as possible—but they are limited by time and expense.

The sorting of cells for purposes such as directed evolution, or genetic research is often conducted on a cell-by-cell basis with a FACS sorter or flow-cytometer type device. While flow-cytometer devices can sort huge numbers of cells, often up to 105 cells per second, it does this by assaying cells with a small number of extremely fast assays. These assays include: the presence or absence of a magnetic label, fluorescence emission from a relevant molecule, or other electrical, mechanical or physical properties. However, the limitation of these assays is that they are looking for specific, known phenotypes in the population. This does not allow one to examine a population for what phenotypes exist and then select the cells with the desired phenotypes.

One application of this type of biological cell sorting is for the directed evolution of cells producing products such as small molecules or proteins. Accepted high-throughput methods for detecting the production of a target molecule from a cell include: agar plates and other plate assays (10⁴-10⁶ variants per experiment), localizing the molecule being produced to the surface of the cell producing it and using FACS (up to ˜10⁹ variants per experiment), and engineering specific fluorescent molecules or biosensors to indicate the presence of the desired product (10⁵-10⁹ variants per experiment). Generally these methods do not reveal the diverse range of molecular products being produced in the population, but only the presence or absence of the intended target. Other methods, such as HPLC-MS and nuclear magnetic resonance (NMR), have the potential to measure the entire range of molecules being produced by a population, but the state of the art of these techniques is accepted to have a limit of around 10³ variants per experiment. This means that traditional high-throughput methods for sorting target molecule producing cells either are only sensitive to a specific target molecule or are limited by the number of cells that can be examined in a given experiment.

Solutions to the problem of locating an individual item in a large set of data are also present in the computer world. Various algorithms exist for the sorting of data. Many of these algorithms are based on using data structures to optimize data operations such as search, insertion or deletion of items. These data structures manage to make the fundamental search operations faster and more efficient by grouping and dividing data into different groups. However, this type of sorting is not physical in nature. These methods are fundamentally different then all types physical searching because they mostly involve the ordering of numbered indexes. Grouping and sorting physical items is more complicated than sorting data for at least the following reasons. The methods and systems described herein involve molecules secreted into a media, and assayed to make a selection decision, whereas computer algorithms rely on mathematical properties of the ordering of the items in the set. The methods and systems described herein method identify molecules on the basis of their function (or any assayable characteristic). A computer sorting algorithm is only capable of finding a specific item or index using a known relationship between the index and the items to be sorted. Furthermore, the methods and systems described herein isolate components (e.g. cells or cells producing a molecule of interest) which are exhibiting interesting and unexpected characteristics or activities as measured by the assay. A computer sorting algorithm is only capable of finding a specific item or index previously identified.

It would be advantageous to provide a mechanism and method for sorting physical items. Specifically, it would be advantageous to provide a mechanism and method for isolating and identifying physical items of interest from a large set of physical items in which the items of interest is rare. For example, it would be advantageous to provide a mechanism and method for isolating and/or identifying cells of interest from a plurality of cells. Similarly, for example, it would be advantageous to provide a mechanism and method for isolating and/or identifying chemicals with properties of interest from a set of separate chemicals. Likewise, for example, it would be advantageous to provide a mechanism and method for performing directed evolution of a target cell producing a target molecule.

### II. OVERVIEW OF PROTOCOL

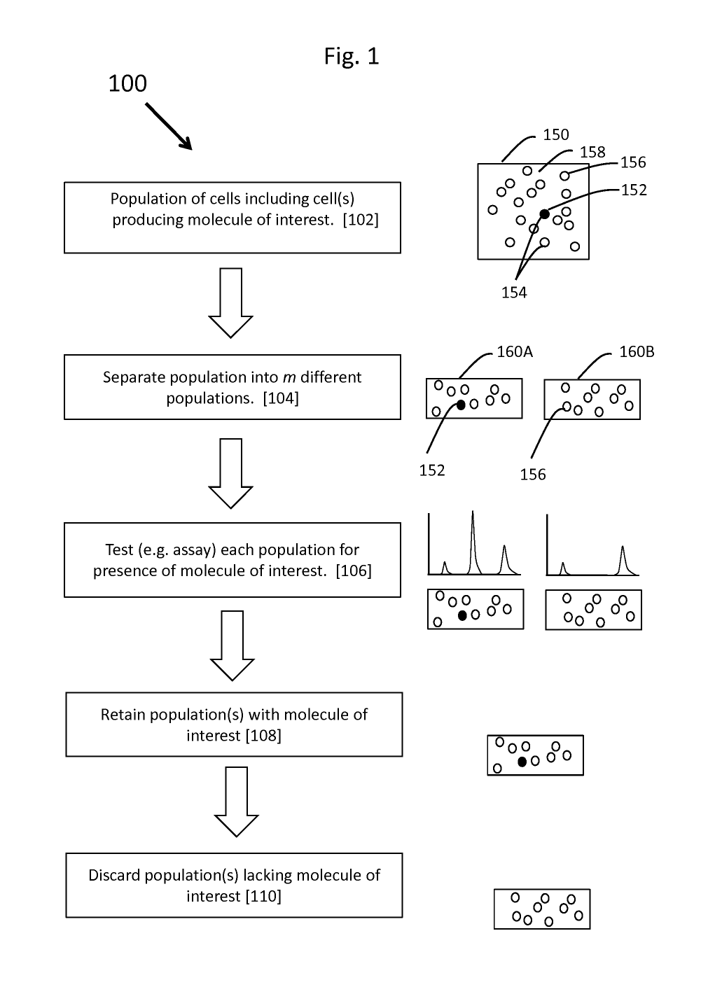

FIG. 1 illustrates a general overview of a protocol for isolating a target cell (100). In some embodiments, the method (100) is performed using test tubes or flasks for holding populations of cells, a centrifuge to separate sample cells from buffer and an assay technique such as HPLC-MS for identification of a characteristic of a target molecule.

This embodiment begins with providing a sample mixture (102). The sample mixture 150 has plurality of sample cells 154, including one or more target cells 152. In some embodiments, the target cell 152, which is the cell desired, is extremely rare as compared to the plurality of non target sample cells 156 in the sample mixture 150. For example, in some sample mixtures one target cell 152 is found for each 1 billion non target sample cells 156. In other sample mixtures one target cell 152 is found for each 1 million non target sample cells 156. In some embodiments, the plurality of sample cells 154 is suspended in a buffer 158.

The sample mixture 150, i.e., the solution of suspended sample cells 154, is split into m different populations (104). In some embodiments, m different populations is two or more separate populations. Each separate population 160 is a subsample mixture of the original sample mixture 150. In the embodiment illustrated in FIG. 1, only one of the two illustrated subsample mixtures 160A and 160B contains a target cell 152. In this case, subsample mixture 160A contains a target cell 152, while subsample mixture 160B contains only non target sample cells 156. In some embodiments, each subsample is contained in a separate centrifuge-able flask or test tube.

Each subsample mixture is tested to determine if a target cell 152 is present (106). In some embodiments, the testing is done as follows. The populations of subsample mixtures 160A and 160B are left in appropriate conditions for sufficient time for the target cells to produce the target molecule in sufficient quantities to be detectable with an assay technique. In some embodiments the appropriate conditions are: 20-30 C with good access to oxygen and in Lysogeny broth, or LB, media. In some embodiments, the sufficient quantities are: 10 nm, 10*10̂-19 molar however more important than a specific number is the limit of detection of whatever assay technique is being used. In some embodiments, the assay techniques include: HPLC-MS, HPLC-IR, Antibody binding assays, fluorescence, spectroscopy, NMR, calorimetric assays, chemical reaction with detectable output. In some embodiments, once sufficient time has passed, the populations are centrifuged to separate them from the buffer solution; the buffer is separated from the population; and each of the populations is re-suspended in fresh buffer. The buffer separated from each population is assayed using one of the appropriate assay techniques described herein.

The population/subsample mixture containing one or more target cells 152 is retained (108). The retained population subsample mixture is then split and tested as per above. In other words, steps 102-110 are performed for the retained population/subsample mixture. In some embodiments, the splitting and testing process is performed iteratively until the target cell 152 is isolated. In other embodiments, the process is iteratively performed until a subsample of a desired size and contains the target cell 152.

A population/subsample mixture which is found to not contain a target cell is discarded (110). For example, any population associated with a negative assay is discarded. In some embodiments, the discarding is performed by removing the population/subsample mixture from a testing device. In other embodiments, the discarding is performed by temporarily holding the subpopulation/subsample mixture and not allowing further testing to be performed. In some embodiments, if both subsample mixtures contain a target cell, one of them is discarded. It should be noted that the discarding 110 and the retaining 108 steps can take place in either order or simultaneously.

### II a) Operation of Protocol for Isolating a Cell of Interest

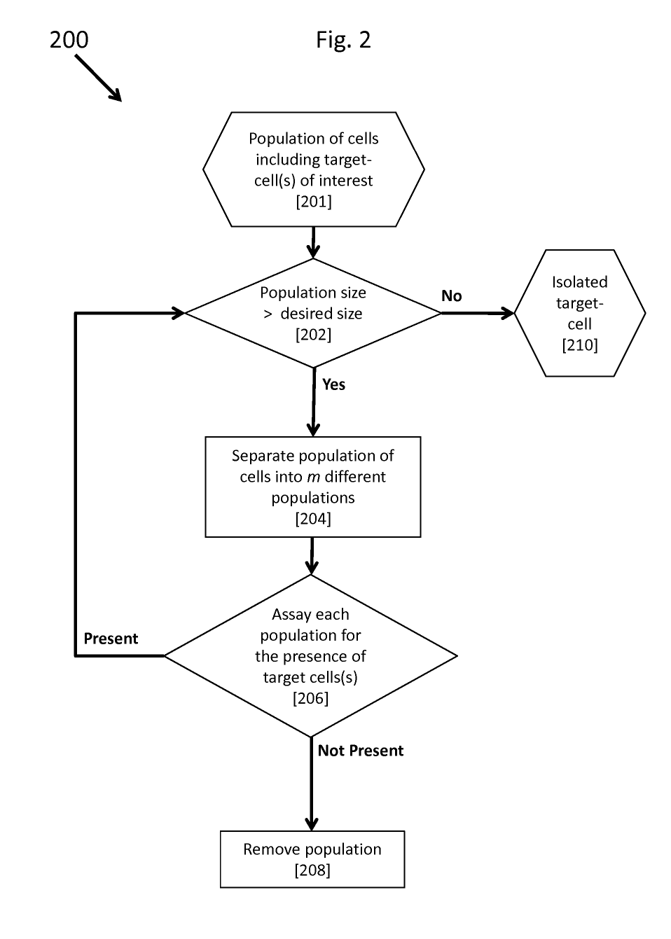

FIG. 2 shows is flowchart illustrating a process to separate, identify, and enrich or isolate cells of interest in accordance with some embodiments (200). Similar, to the protocol illustrated in FIG. 1, in some embodiments of FIG. 2, the method (200) is performed using test tubes or flasks for holding populations of cells, a laboratory centrifuge and an assay method such as HPLC-MS. This embodiment starts with providing a sample mixture with a population of sample cells 154 that contains one or more target cells 152 suspended in a buffer 158 (201). The population size of the sample mixture (or subsample mixture) is determined to see if it is at a desired size, i.e, to see if the total number of sample cells is a desired number (202). When the desired size is reached, an isolation criterion is met. In some embodiments, the desired size is one cell, which is the target cell 152. In other embodiments, the desired size is at least one tenth, one one-hundredth, or one one-thousandth of the size of the original sample mixture. In still other embodiments, the desired size is at least 10%, 20%, or 50% target cells 152. In some embodiments, the desired size is between about one cell to about five cells, or between about one cell to about ten cells, or between about one cell to about 25 cells, or between about one cell to about 50 cells, or between about five cells to about ten cells, or between about five cells to about 25 cells, or between about five cells to about 50 cells. When the population size is not larger than a desired size and contains a target cell, the target cell 152 is considered isolated (210). In some embodiments, the isolated target cell or isolated target cell mixture is retained for eventual removal and further processing. In other embodiments, the isolated target cell or isolated target cell mixture removed and stored in a place separate from the remainder of the original sample mixture. When the population size is larger than a desired size (and contains a target cell) a retention criterion has been met, so the process continues. The sample cells mixture is split into two or more separate populations/subsample mixtures (204). In some embodiments, each subsample mixture is contained in a separate centrifuge-able flask or test tube. In some embodiments, the populations are left in appropriate conditions for sufficient time for the target cells to produce the molecule of interest in sufficient quantities to be detectable (such as with one of the assay techniques previously described herein). In some embodiments, once sufficient time has passed, the populations are centrifuged to separate them from the buffer solution; the buffer is separated from the population; and each of the populations is re-suspended in fresh buffer. The buffer separated from each population is assayed for the presence of the target cell(s) (206). At least one population is removed/discarded (208). In some embodiments, a population associated with a negative assay is discarded. In other embodiments, when all the populations assayed have the target cell(s), one or more population associated with the positive assay will be discarded, while at least one population associated with the positive assay will be retained. The remaining enriched population(s) (containing the target cells) are split (204) and re-assayed (206) as per above. This is performed iteratively until an isolation criterion is met. In some embodiments, the isolation criterion is met when the mixture contains a target cell and the respective subsample mixture is not larger than a desired size.

### II b) Operation of Performing Directed Evolution of Cells Producing a Molecule of Interest

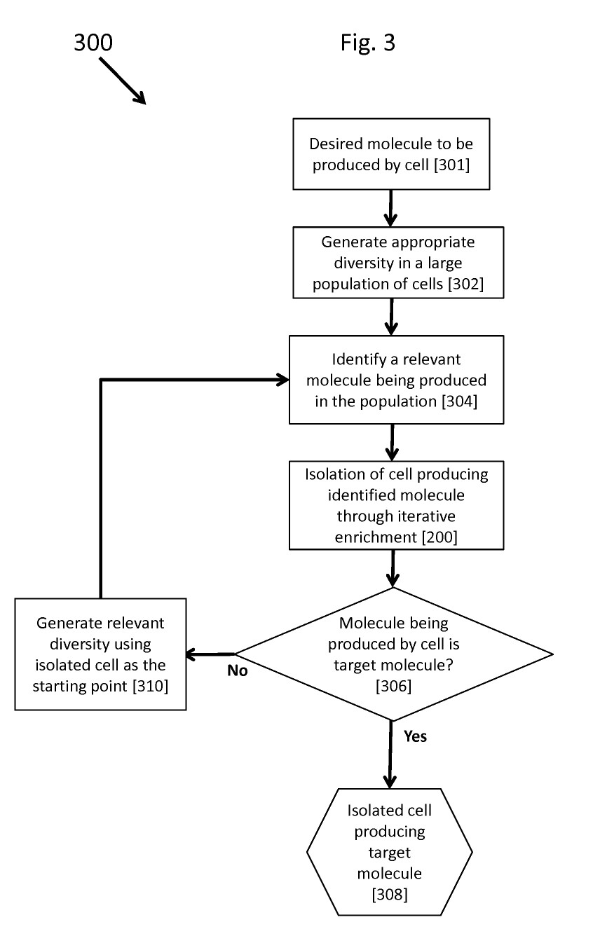

FIG. 3 illustrates a process of performing directed evolution of molecule producing cells in accordance with some embodiments (300). This embodiment starts by identifying a desired molecule, such as a target molecule, to be produced by a cell (301). An appropriate diversity of cells in a large population of cells is generated or obtained (302). The population is tested to determine if the desired molecule, such as a target molecule, is being produced in the population (304). In some embodiments, the one or more sample populations are assayed for the presence of desired molecule, such as a target molecule. In some embodiments, the assay is conducted by: detecting a desired molecule, such as a target molecule, being produced by the cell with techniques such as HPLC-MS, NMR, antibodies or other methods; lysing the progeny of the current population and examining their cytoplasm with techniques such as HPLC-MS, NMR, antibodies or other methods; detecting a target signal being produced by the population with a microscope, ammeter, or other device; or other methods. Then the cell producing the identified molecule, such as a target molecule, is identified through iterative enrichment, such as the method described in FIG. 2 (200). It is determined whether the molecule being produced by the cell is the target molecule (306). When the molecule produced is the target molecule, the cell producing the target molecule is isolated (308). When the molecule produced is not the target molecule, a new relevant diversity is generated using the isolated cell as the starting point (310). Then the process is iterated until determining that the molecule being produced by the cell is the target molecule (306) and this cell producing the target molecule is isolated (308).

An example application of a system using the method of FIG. 3 is described below.

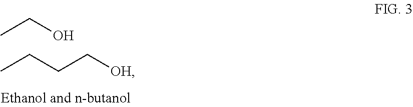

Directed evolution can involve the ethanol metabolism network in Saccharomyces cerevisiae to produce a different, related molecule -n-butanol. S. cerevisiae produces approximately 6 fmol/cell/s of ethanol. Given a flow rate of buffer over the cells of 1 μL/s means that in one second a single cell would produce an amount of ethanol nine orders of magnitude above the limit of detection for an advanced HPLC-MS. There are 672 genes involved in the ethanol metabolism in S. cerevisiae. This represents approximately 10⁶ base pairs out of a total of the approximately 10⁷ base pairs in S. cerevisiae, giving us N=10⁷. Mutagenesis corresponding to completely changing 100 base pairs would give us n=100. If we divide the population into 10 parts at each iteration, with a measurement time of approximately 15 minutes, we will then have s=10, τ_{assay}=15 minutes. Normal yeast has a growth rate k=0.008/min. The maximum reasonable population size of S. cerevisiae is M=10¹⁴=(3N/q)^{q}→q=2→i=50. That means that on average each iteration will create two mutations, and there will be fifty iterations. Given these variables we can calculate the time of evolution:

$$\begin{matrix}{τ}_{evolution} ( N , n , i , k , s ) = {n}^{*} ( ln ( 3 {N}^{*} i / n ) / k + {{log}_{s} ( 3 {N}^{*} i / n )}^{*} {τ}_{assay} ) \\ = {100}^{*} ( \begin{matrix}ln ( {3}^{*} {( 10 \hat{} 7 )}^{*} 50 / 100 ) / .008 / min + \\ {{log}_{10} ( {3}^{*} {( 10 \hat{} 7 )}^{*} 50 / 100 )}^{*} 15 min\end{matrix} ) \\ = {100}^{*} ( 33 hours + 1.8 hours ) \\ = 145 days\end{matrix}$$

However if we were to do the same number of mutations, but instead of targeting the whole genome we use a plasmid technique to only target the genes in the ethanol metabolic network, we would have N=10⁶. If we estimate that our PCR process takes 2 hours per iteration this would give a time of evolution,

τₑᵥₒₗᵤₜᵢₒₙ=100*(2 hours+1.5 hours)=14.58 days

The main time limiting factors for this method are the number of mutations, and the culture growth rate (or PCR time) and maximum size of that culture and the sorting time. This means that this method is powerful enough that it requires the most advanced methods of directed diversity generation, and the maximum possible population size and the fastest sorting techniques. These above calculations show that S. cerevisiae has a slow division rate and relatively low maximum density would not allow for easy sorting. That being said, the time scale over which major changes can be selected for is a period of weeks to a year, which is practically feasible. Further, because most of the time is spent on growing the cultures, many different selection processes can go on in parallel with the same setup—the selection system is scalable for industrial applications.

### II c) Operation of Protocol for Isolating a Chemical of Interest

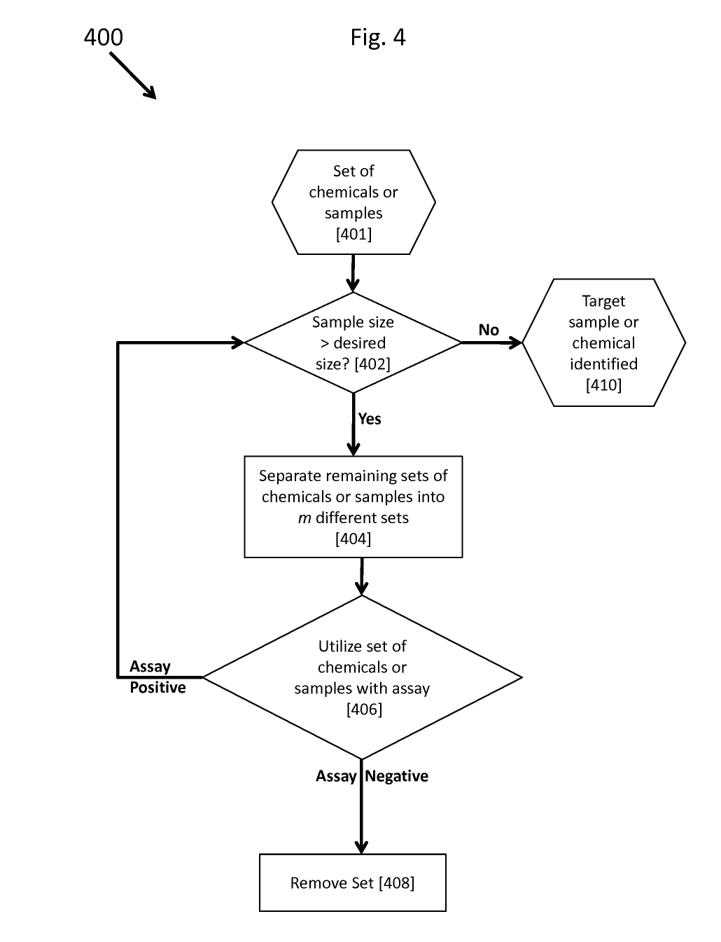

FIG. 4 shows a flowchart describing the process (400) to separate, identify, enrich or isolate a chemical or a sample from a set of chemicals or samples in accordance with another embodiment. This embodiment consists of a process for identifying a chemical with rare properties or uses from a sample set of chemicals. This embodiment starts with a set of chemicals or samples (401). This can be a mixture of chemicals, a group of separate and unmixed chemicals, a natural product extract, a set of drug test samples, a set of samples of food products, or any other type of chemicals or samples. (Prior to beginning this process, the mixture is tested to determine the presence or absence of the target properties of the chemical or the presence of any other rare target sample.)

The sample mixture (or subsample mixture) is tested to see if it is at a desired size/to see if an isolation criterion is met (402). If not, the set(s) of chemicals or samples are separated into two or more different sets (404). In some embodiments, this includes physically separating the contents of each sample through column separation or some other method into subsets; assembling “m” preparations of subsets of the samples or chemicals contained in the previous sample of set of chemicals, all together containing every sample or chemical in the previous set; and other ways of reorganizing the prior set of chemicals or samples into multiple sub-sets. Then, utilize each set of chemicals or samples created in the prior step are tested for the presence of the target chemical (406). In some embodiments, an appropriate assay is used for testing. This assay can be an assay for drug efficacy, a drug test, a test for contaminated food or other tests and assays.

At least one population is removed/discarded (408). In some embodiments, each set of chemicals or samples that does not test positive is removed/discarded. In other embodiments, when all the populations assayed have the target chemical, one or more population associated with the positive assay will be discarded, while at least one population associated with the positive assay will be retained. The remaining sample(s) are split (404) and re-tested (406) as per above. This is performed iteratively until an isolation criterion is met. In some embodiments, the isolation criterion is met when the mixture contains the target chemical and the respective subsample mixture is not larger than a desired size. Then the remaining target chemical is identified (410).

### II d) Operation of Protocol for Isolating a Physical Item of Interest

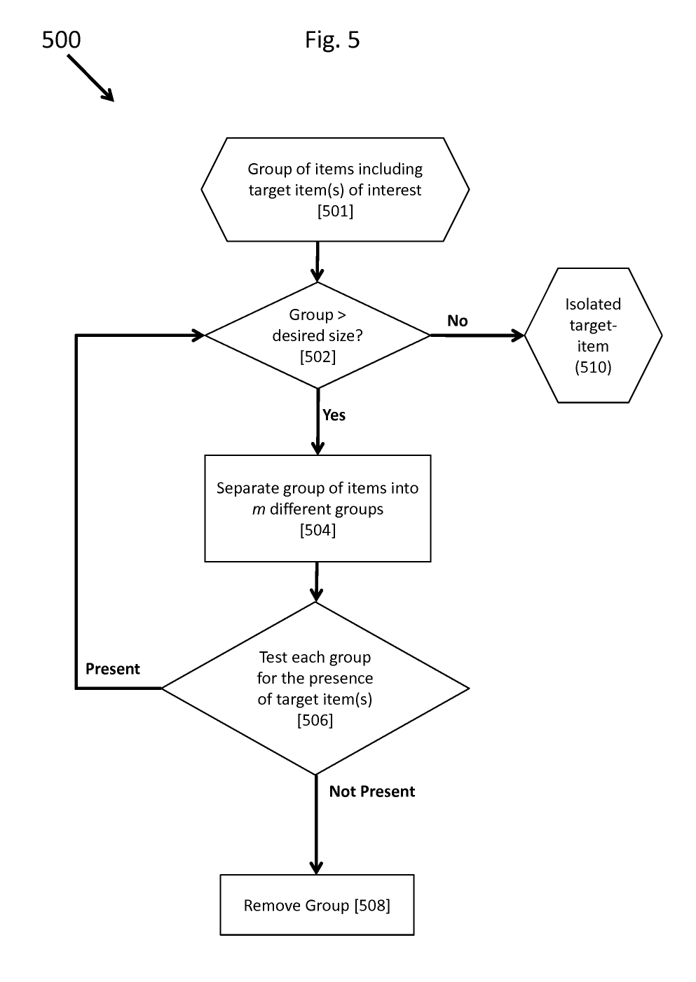

FIG. 5 shows a flowchart describing the process (500) to separate, identify, and isolate a physical item of interest from a set of physical items in accordance with one embodiment. This embodiment is similar to the embodiments of FIGS. 1-4 described above, and the details described therein are applicable in this embodiment as well. This embodiment starts with a group or mixture of sample physical items including a target physical item (501). The group tested to see if it is at a desired size/to see if an isolation criterion is met (502). If not, the set(s) of group of items are separated into two or more different subgroups (504). Then each subgroup created in the prior step is tested for the presence of the target physical item (506). In some embodiments, the testing is performed to determine the presence of a target physical item based on one of its unique properties. For example, in some embodiments the testing is performed by a filtering process if the target physical item is of a unique size. In other embodiments, the testing is performed using a magnetic process if the target physical item exhibits unique magnetic properties. At least one subgroup is removed/discarded (508). In some embodiments, each set of chemicals or samples that does not test positive for having the target physical item is removed/discarded. In other embodiments, when all the subgroups tested have the target physical item, one or more “positive” subgroups is discarded, while at least “positive” subgroup retained. The remaining subgroup(s) are further split (504) and re-tested (506) as per above. This is performed iteratively until an isolation criterion is met. In some embodiments, the isolation criterion is met when the mixture/group contains the target physical item and the mixture/group is not larger than a desired size. Then the remaining target physical item is identified (510).

Thus, in some embodiments, a method of isolating of a target component from a plurality of sample components is provided. The method is performed as follows. A sample mixture comprising one or more sample components including a target component is received. The sample components of the sample mixture are divided into at least two subsample mixtures each comprising one or more sample components. At least two subsample mixtures are tested for the presence of a target component. A respective subsample mixture of the at least two subsample mixtures is discarded when a discard criterion is met. Furthermore, a respective subsample mixture of the at least two subsample mixtures is retained when a retention criterion is met. The dividing, testing, discarding, and retaining are iteratively performed until an isolation criterion is met.

In some embodiments, the method includes isolating of a target cell from a plurality of sample cells. In this embodiment, the one or more sample components are one or more sample cells, and the target component is a target cell. The at least two subsample mixtures each comprising one or more sample cells. Furthermore, the testing comprises assaying the at least two subsample mixtures for the presence of the target cell.

In some embodiments, the assaying includes one or more of the following techniques: detecting a target molecule being produced by the target cell; lysing the progeny of the respective subsample mixture and examining their cytoplasm; and detecting a target signal being produced by the respective subsample mixture.

In some embodiments, the method includes identifying one or more chemicals with one or more properties of interest from a set of separate chemicals. In this embodiment, the one or more sample components are one or more sample chemicals. The target component is a target chemical. The at least two subsample mixtures each comprising one or more sample chemicals. Furthermore, the testing comprises testing the at least two subsample mixtures for the presence of the target chemical by testing for the one or more properties of interest.

In some embodiments, the method includes identifying one or more physical items of interest from a set of separate physical items. The one or more sample components are one or more sample physical items. The target component is a target physical item. The at least two subsample mixtures each comprise one or more sample physical items. Furthermore, the testing comprises testing the at least two subsample mixtures for the presence of the target physical item.

### III. OVERVIEW OF MICROFLUIDIC APPARATUS

The process of separating a component of interest from a plurality of sample components is performed using an apparatus described herein. One such apparatus is a microfluidic apparatus having a branched or tree structure which can be used for separating a cell secreting a molecule of interest from a plurality of cells in a sample mixture. Another such apparatus is a microfluidic apparatus having a looped structure which can be used for separating a cell secreting a molecule of interest from a population of cells (e.g., a plurality of cells). In an exemplary embodiment, the components of the apparatus are described herein in the context of a microfluidic apparatus. In an exemplary embodiment, the apparatus can comprise or consist of a series of channels, valves, and chambers that selectively follow into one another. In the Figures provided herein, the sample mixture flows from the top of a figure to the bottom of a figure. However, this does not necessarily imply that the apparatus is required to be in an upright position. In some embodiments, the apparatus is a microfluidic apparatus which is positioned on a laboratory slide, wherein the channels, valves, and chambers are coplanar. In some embodiments the channels, valves, and chambers are made of one or more of the following: glass, polydimethylsiloxane (PDMS), plastic, or other materials exhibiting similar properties.

With respect to particular details of the methods and apparatuses according to the present invention, a sample mixture may be delivered to the one or more input channels (described in more detail below) by any means known in the art. For example, a sample mixture may be delivered by directly applying the sample mixture into or on the input channels either manually or by robotic liquid handling systems, or by utilizing a delivery device with microfluidic channels to deliver the sample mixture into or on the input channels. Direct application of the sample mixture to the input channel can be done via a device such as a syringe or a pipette.

“Microfluidic apparatus,” as used herein, refers to a system or device having channels, valves, and chambers that are typically fabricated at the micron to submicron scale. Generally, the channels have at least one cross-sectional dimension in the range of from about 0.1 micron to about 500 microns.

The cross-sectional dimension of channels or flow splitters or chambers or valves described herein should be large enough to prevent clogging. In some embodiments, the cross-sectional dimension is about two times, or about three times, or about four times, or about five times, or about six times, or about seven times, the diameter of a cell in the sample mixture. In some embodiments, the cross-sectional dimension of a channel or a flow splitter or a chamber or a valve is between about 0.1 micron and 50 microns, or between about 1 microns and 50 microns, or between about 1 micron and 100 microns, or between about 10 microns and 100 microns, or between about 25 microns and 200 microns. In some embodiments, the chambers described herein are configured to hold a volume between about 0.001 microliters to about 10 microliters, or between about 0.01 microliters to about 10 microliters, or between about 0.1 microliters to about 10 microliters, or between about 1 microliter to about 10 microliters, or between about 0.1 microliter to about 1 microliter, or between about 0.1 microliter to about 5 microliters, or between about 1 microliter to about 5 microliters. Typically, about 50% or about 60% or about 70% or about 80% or about 90% of the volume of a cell chamber are filled when the flow rate is adjusted or regulated. The flow rate by which the sample mixture is delivered to the microfluidic apparatus can be adjusted by known methods.

The microfluidic apparatus may be fabricated from materials that are compatible with the conditions present in the particular use of interest. Such conditions include, but are not limited to, pH, temperature, ionic concentration, pressure, and application of electrical fields. The materials of the microfluidic apparatus may also be chosen for their inertness to components of the sample mixture to be utilized in the apparatus. Such materials include, but are not limited to, glass, co-polymer or polymer, most preferably urethane, rubber, molded plastic, polymethyl methacrylate (PMMU), polycarbonate, polytetrafluoroethylene (TEFLON), polyvinyl chloride (PVC), polydimethylsiloxane (PDMS), polysulfone, and the like, depending on the intended application. Additional examples of plastics materials which can utilized include polyolefin plastics or polyethylene plastics. In some embodiments, it is important to utilize materials in the methods and apparatus with which the target molecule will essentially not interact. In some embodiments, interaction includes adsorption and/or absorption. Examples of treatments to PDMS are described in Makamba, et al., Electrophoresis, 24, 2132-2139 (2003). In some embodiments, the microfluidic apparatus is treated to prevent this interaction. In some embodiments, the microfluidic apparatus is treated with TEOS (tetraethyl methacrylate) for avoid target molecule absorbance from the PDMS (as described in Gomez-Sjoberg, Anal. Chem., 82, 8954-8960 (2010)). In some embodiments, the microfluidic apparatus is treated with a protein such as casine protein. In some embodiments, the hydrophobicity of the microfluidic apparatus is modified by cleaning in a plasma-cleaner. Examples of flow gratings which are compatible with target molecules, such as, but not limited to proteins, include polycarbonate filters, nitrocellulose filters, PDMS filters and glass filters. In addition to the apparatus materials, the sample mixtures, and their corresponding buffers, must be selected for compatibility with the target molecule. In some embodiments, such as when a protein is the target molecule, buffer conditions which prevent or reduce aggregation are desired.

The flowing of the sample mixture through the microfluidic apparatus may be carried out by a number of mechanisms, including, for example, gravity based flow, pressure based flow, electrokinetic flow, or mechanisms that utilize a hybrid of one of more of these. The microfluidic apparatus may also include integrated microfluidic structures, such as micropumps and microvalves, or external elements, e.g., pumps and switching valves, for the pumping and direction of the sample mixture through the microfluidic apparatus.

In any of the method or apparatus embodiments described herein, some or all of the described components are directly coupled to one another. In any of the method or apparatus embodiments described herein, intervening components are used to couple the described components to one another.

### III a) Microfluidic Apparatus Having Branched or Tree Structure

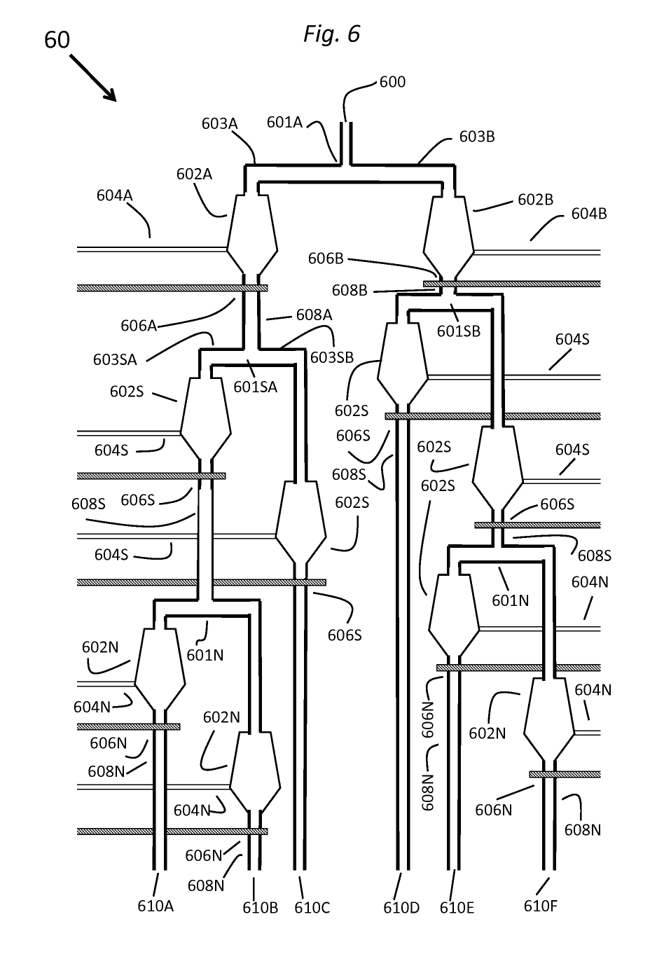

In some embodiments, the process of separating a component of interest from a plurality of sample components is performed using a device, such as an apparatus having a branched or tree structure, as illustrated in FIG. 6. One such apparatus is a microfluidic apparatus having a branched or tree structure 60 which can be used for separating a cell secreting a molecule of interest from a plurality of cells.

In accordance with some embodiments, the microfluidic apparatus having a branched or tree structure 60 comprises one or more input channels 600. In some embodiments, the input channel 600 is a physical channel (i.e., a typical tube suitable for this apparatus), while in other embodiments the input channel is a cell chamber, and in still other embodiments it is an input receiving means such as an aperture or hole for receiving a sample mixture.

The input channel 600 connects either directly or indirectly to a flow splitter 601A. A flow splitter (such as 601A, and flow splitters in other embodiments of this application) is a mechanism configured to divide an input such as a sample mixture, into two or more outputs or subsample mixtures. In some embodiments, the flow splitter (e.g., 601A) is configured to produce two or more subsample mixtures of essentially the same size or volume. In some embodiments, the flow splitter is a T or Y shaped channel. In other embodiments the flow splitter is a selective filter. In some implementations, the flow splitter (e.g. 601A) is configured to divide a sample mixture into at least two subsample mixtures wherein each subsample mixture comprises substantially the same number of sample cells. In some embodiments, substantially the same number of sample cells are separated in each subsample mixture, because the population is uniform (e.g., it is well mixed or homogeneous) and the branches of the Y or T are substantially identical to one another (e.g., they have essentially the same diameter). In other embodiments, the flow splitter (e.g. 601A) is configured to divide a sample mixture into at least two subsample mixtures wherein at least one subsample mixture comprises a substantially unequal number of sample cells in relation to the other subsample mixtures. In some embodiments, the flow splitter (e.g., 601A) filters larger sample cells from smaller sample cells. In other examples, the flow splitter (e.g., 601A) separates stickier cells from less sticky cells (e.g., antibody treated cells). As used herein “sticky” cells are those more likely to selectively attach or stick to a particular surface or to other cells. In some embodiments, the flow splitter separates the more rigid cells from more squishy cells (e.g., it separates cells based on their deformation characteristics) more massive cells from lighter cells (e.g., it separates cells based on weight) using appropriate separation mechanisms For example, in some embodiments the flow splitter (e.g. 601A) will use one or more stages of affinity surfaces to perform an affinity separation such as those described in Wigzell and Anderson (1969) J. Exp. Med. 129:23.

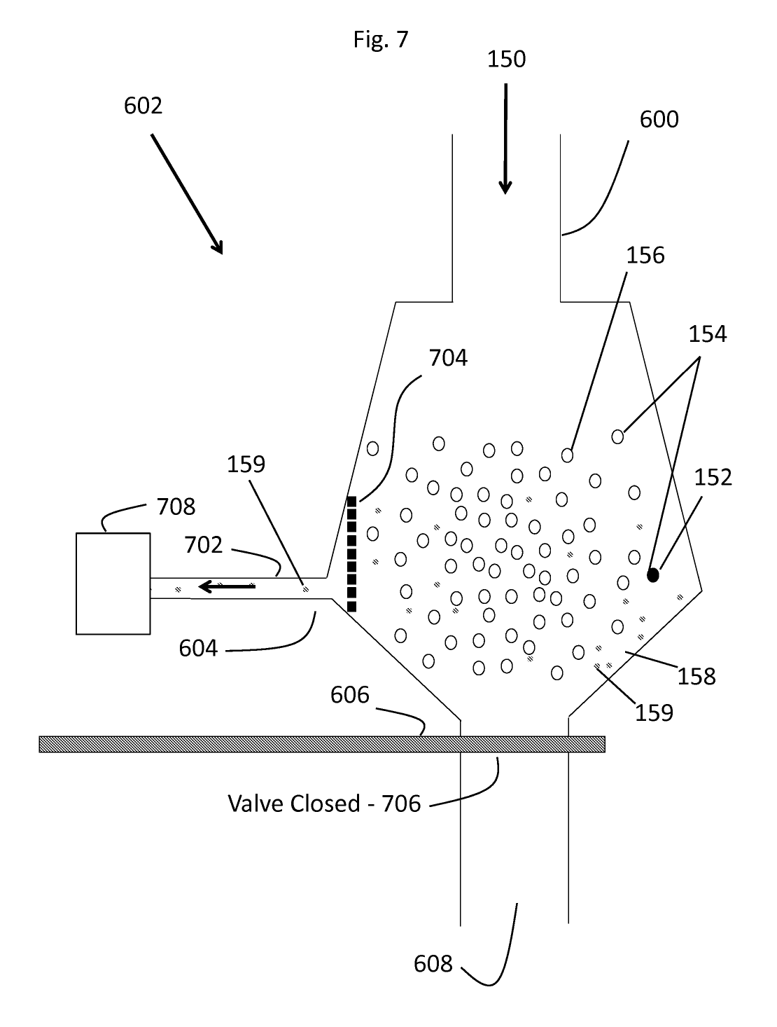

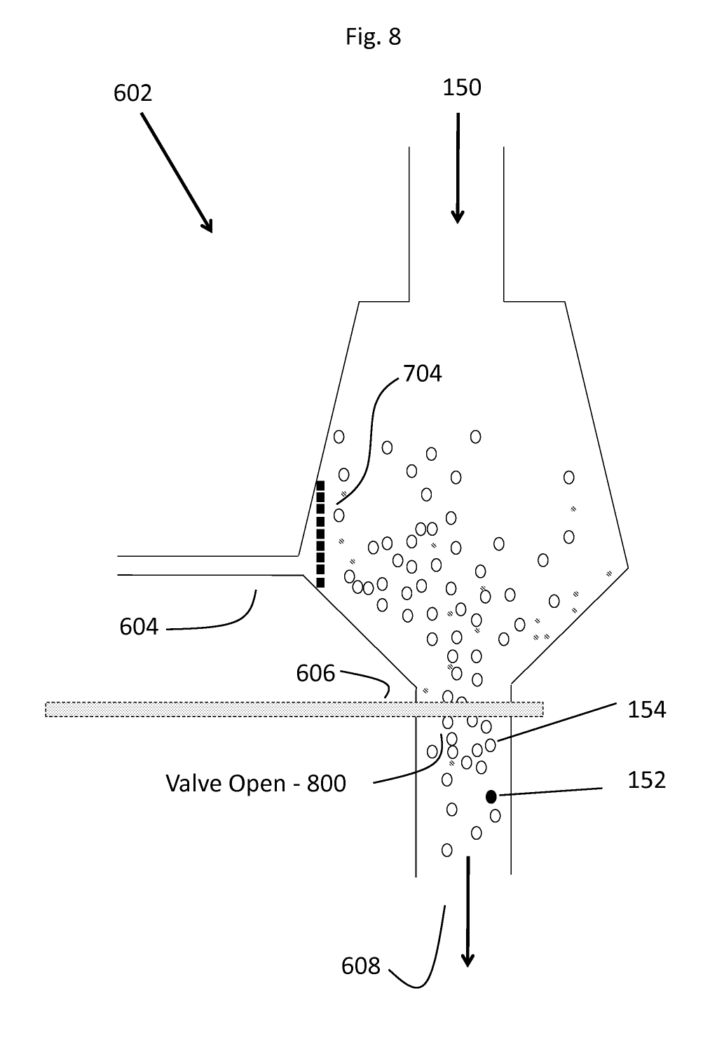

In some implementations, the flow splitter 601A includes one ingoing channel and at least two outgoing channels. In FIG. 6, the flow splitter 601A has input channel 600 as its ingoing channel and outgoing channels 603A and 603B. Likewise, in FIG. 6, a flowsplitter 601SA has output channel 608A as its ingoing channel and outgoing channels 603SA and 603SB. The outgoing channels 603 of the flow splitter 601A connect directly or indirectly to cell chambers 602, such as cell chambers 602A and 602B illustrated in FIG. 6. A more detailed description of a cell chamber is provided herein, such as in section IIIb and as illustrated in FIG. 7 and FIG. 8. As illustrated in FIG. 6, cell chambers 602A and 602B of the microfluidic apparatus having a branched or tree structure 60 each have a sample cell testing element 604A and 604B, an output valve 606A and 606B, and an output channel 608A and 608B, which are further attached to subsequent flow splitters 601S and cell chambers 602S for further splitting and testing the subsample mixtures into sub-subsample mixtures, sub-sub-subsample mixtures, etc. In some embodiments, a microfluidic apparatus having a branched or tree structure 60 has three levels, wherein each level comprises one or more flow splitters 601 and a plurality of cell chambers 602 and output channels 608. In other embodiments, the microfluidic apparatus having a branched or tree structure 60 has between three and fifteen levels of cell chambers 602 and splitters 601. In still other embodiments, the microfluidic apparatus having a branched or tree structure 60 has more than fifteen levels of cell chambers 602 and splitters 601.

At the end of each final branch or level (level N) of the microfluidic apparatus having a branched or tree structure 60 is a final output channel 610. FIG. 6 illustrates final output channels 610A-610F. The final output channels 610A-610F illustrated in FIG. 6 are connected to cell chambers 602 at varying levels of the branched structure. In other embodiments of the microfluidic apparatus having a branched or tree structure 60 each level, except for the final level, has one or more flow splitters 601 and two or more cell chambers 602 and output channels 608, but no final output channels 610. In this embodiment, each of the last level cell chambers 602N leads to a final output channel 610. In other words, in this embodiment, all of the final output channels 610 branch off of the same level of the tree structure, the final level (level N).

In some embodiments, some or all of the final output channels 610 re-join one another to form a common output channel. This is beneficial for efficiently removing unwanted portions of the sample mixture. For example, multiple subsample mixtures that do not contain a target cell can be simultaneously removed using the common final output channel. In other embodiments, the final output channels 610 are each distinct. In these embodiments, that a subsample mixture from a cell chamber at the final level (level N) of the microfluidic apparatus having a branched or tree structure 60 can be separately captured using its distinct final output channel. For example, when the cell chamber 602N contains a sample mixture with a target cell, the sample cell (or mixture containing the sample cell) is efficiently captured through the final output channel 610N used only for that cell chamber 602. It should be noted, in embodiments where the final output 610 channels are not distinct, the target cell, or target cell mixture will be removed separately from the unwanted portions of the sample mixture. For example, in some implementations, the mixture containing the target cell is removed through the common output channel prior to the removal of the unwanted portions of the sample mixture. In other embodiments, the mixture containing the target cell is removed after the unwanted portions are removed. In other implementations, the mixture containing the target cell is not removed through a final output channel, but is held until it is removed directly from the cell chamber 602, or captured via an alternative means.

It is noted, that in some implementations, the microfluidic apparatus having a branched or tree structure 60 is mounted on a heating plate. In other implementations, the microfluidic apparatus is mounted on a cooling plate. This optional mounting on a heating or cooling plate allows the microfluidic apparatus to be heated or cooled respectively during the cycle/separation process. In some embodiments, the temperature provided by the heating or cooling plate to the microfluidic apparatus can be any biologically viable temperature. As such, in some embodiments a microfluidic apparatus (either in FIG. 6 or FIG. 9 or FIG. 10) further comprises a temperature control means, which heats at least a portion of the apparatus to a biologically viable temperature. In some embodiments, biologically viable temperatures include 0-40 degrees Celsius (depending on the organism) In some embodiments, cooling the microfluidic apparatus can stop or retard cell division activity which, in some implementations, is beneficial while an assay technique is being performed. In some embodiments, heating the microfluidic apparatus can encourage cell division activity which, in some implementations, is beneficial for generating relevant diversity in a population of cells when performing directed evolution. In some embodiments, the microfluidic apparatus is mounted to a plate with both heating and cooling capabilities, which are used to selectively heat and cool the plate during various portions of the cycle in accordance with whether cell division activity is to be encouraged or discouraged.

### III b) Detailed View of a Cell Chamber

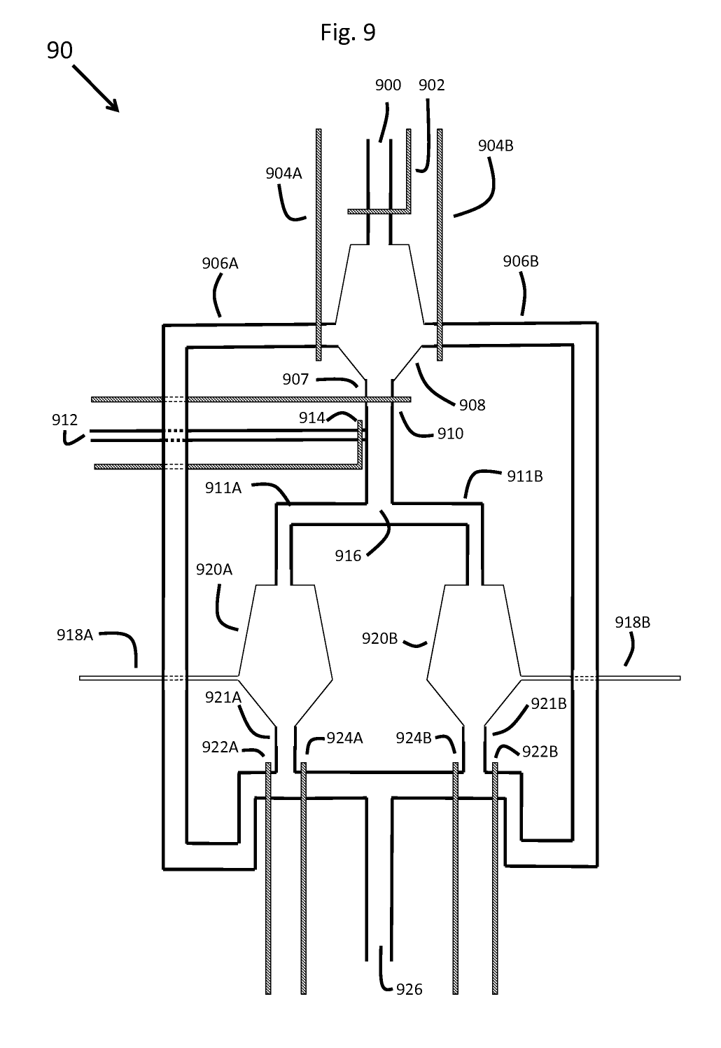

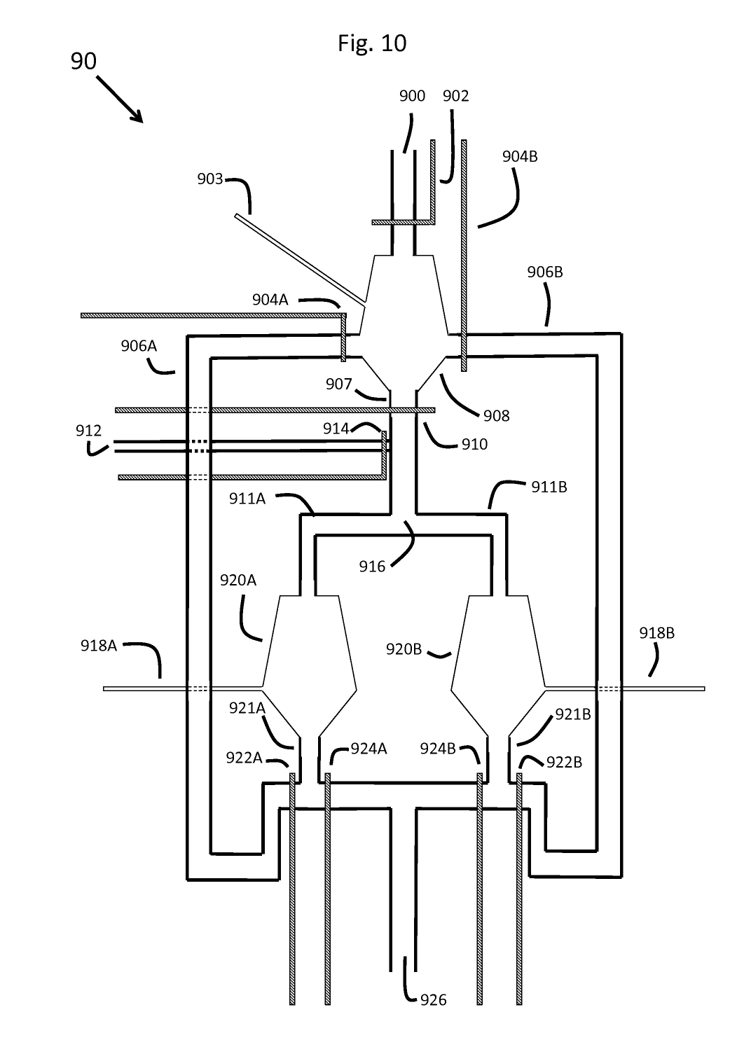

FIG. 7 shows one embodiment of the cell chamber 602 with the output valve 606 closed 706. In some implementations, the cell chamber 602 is used in the microfluidic apparatus having a branched or tree structure 60 illustrated in FIG. 6. In other implementations, the cell chamber 602 is used in the microfluidic apparatus having a looped structure 90 illustrated in FIG. 9 and FIG. 10. When the output valve 606 is closed, at least some of the buffer 158 (and target molecules 159 when present) are provided to the sample cell testing element 604 as described in more detail below. In some embodiments, a valve is also placed in front of flow grating 704 to prevent passive outflow of buffer through 702.

The input channel 600 is configured to receive a sample mixture 150. The sample mixture 150 has a plurality of sample cells 154, including one or more target cells 152. The sample mixture 150 may also contain buffer 158 and target molecule(s) 159. It should be noted that, throughout this application, unless specifically referring to the sample mixture originally provided to an apparatus at the beginning of a process, the term sample mixture 150 also includes subsample mixture, sub-sub sample mixture, or any later iterative portion of the sample mixture 150. Furthermore, throughout this application, the term subsample mixture is used to also mean a sub-sub sample mixture, a sub-sub-sub sample mixture, or any later iterative portion of the sample mixture. In other words, in general a subsample mixture is any second or subsequent iteration or portion of the original sample mixture, whereas sample mixture includes the original sample mixture and any second or subsequent iteration or portion. The sample cell testing element 604 (illustrated here as including a testing channel 702, a flow grating 704, and a testing apparatus 708) is configured to test the sample mixture for the presence of one or more target molecules 159 (which indicates the presence of a target cell 152 in the sample mixture 150). In some embodiments, the cell chamber testing element 604 comprises a testing channel 702 and a flow grating 704 but does not include a testing apparatus 708. In other embodiments, the cell chamber testing element 604 comprises a flow grating 704 and a testing apparatus 708 but does not include a testing channel 702. In some embodiments, the testing apparatus 708 is a part of a microfluidic apparatus (e.g., 60 or 90). In other embodiments, the cell chamber testing element 604 is attached to a testing apparatus 708 which is distinct from the microfluidic apparatus (e.g., 60 or 90). Whether a part of or distinct from the microfluidic apparatus (e.g., 60 or 90), the testing apparatus 708 performs an assay to identify a characteristic of the target molecule 159, thus identifying the target molecule 159 (which indicates the presence of a target cell 152 in the sample mixture 150). In some embodiments, the assay determines the presence or absence of the target molecule in the sample mixture. In other embodiments, the assay determines the quantity of the target molecule in the sample mixture. In some embodiments, the characteristic of the target molecule is molecular weight. A testing apparatus which would assay for the molecular weight of a target molecule is mass spectrometry. In some embodiments, the characteristic of the target molecule is its response to infrared energy. A testing apparatus which would assay for the response to infrared energy of a target molecule is infrared spectroscopy. In some embodiments, the testing apparatus conducts assay techniques such as NMR.

The sample channel 702 and flow grating 704 are attached in such a way as to allow a portion of the buffer 158 (and target molecule(s) if any) to be removed from the sample mixture 150, while leaving the plurality of sample cells 154 in cell chamber 602, as is illustrated in FIG. 7. In some embodiments, the flow grating 704 is a filter with pores having diameters small enough to prevent a sample cell 154 from passing there through but having diameters large enough to allow the buffer with target molecule(s) 159 to pass there through. In some embodiments, the flow grating 704 is a polycarbonate filter. In some embodiments, the flow grating 704 has an average pore diameter of between 0.1 and 0.5 microns. In some embodiments, the flow grating 704 is a polycarbonate filter having an average pore diameter of between 0.5 and 2 microns. In some embodiments, the flow grating 704 has an average pore diameter of between 0.1 and 0.5 microns. In some embodiments, the flow grating 704 is a polycarbonate filter having an average pore diameter of between 0.5 and 2 microns. In some embodiments, the flow grating 704 is a polycarbonate filter having an average pore diameter of between 0.1 and 2 microns. In some embodiments, the flow grating 704 is a PDMS filter made of a series of channels in PDMS to small to allow the cells to pass but large enough to allow the buffer and target molecule(s) 159 to pass there through in accordance with the same ranges provided above. In some embodiments, glass filters, quartz fiber filters, Teflon filters, nitrocellulose filters are used, which also allow buffer with target molecule(s) 159 to pass there through in accordance with the same ranges provided above.

In some embodiments, the testing channel 702 in FIG. 7 is attached in such a way as to allow buffer 158 to pass from cell chamber 602 to testing apparatus 708. In other embodiments, the output channel 608 can also be used as a sample cell testing element instead, e.g., when a sieve or other type of valve allowing flow is used for the output valve 606. In this embodiment, the output valve 606 is sieve valve has three states—open, closed and filtering. When the output valve 606 is being used to take a sample, it is in the filtering state. The buffer containing the target molecule is flowed through the sieve valve and then tested. For example, in FIG. 9, in some embodiments, an output sieve valve is used for discard valves (e.g., 924A and 924B). The discard valve 924A is set to a filtering state and buffer and target molecules from are flowed from secondary cell chamber 920A through the sieve discard valve 924A out of through the output channel 926 and collected for testing. Then the discard valve 924A is set to closed, and discard valve 924B is set to a filtering state and same process is then performed separately for the subsample mixture in secondary cell chamber 920B.

FIG. 8 shows one embodiment of the microfluidic cell chamber 602 with the output valve 606 open 800. When the output valve 606 is open, the sample cells of the sample cell mixture (or subsample mixture) flow out the output channel 608. In some embodiments, a portion of the buffer 158 (and target molecules 159 when present) also flow out the output channel 608.

### III c) Operation of a Microfluidic Apparatus Having a Branched or Tree Structure

Now that a detailed description of the cell chamber 602 has been provided, the operation of an embodiment of the microfluidic apparatus having a branched or tree structure 60 as illustrated in FIG. 6 will be described. The embodiment consists of one or more input channel 600 where a sample mixture is introduced (e.g. by flowing the cells, the buffer and/or other materials using either a push or pull type flow.) Operation of the embodiment starts by flowing a sample mixture 150 into the input channel 600. The sample mixture is divided into at least two subsample mixtures 160A and 160B by introducing the sample mixture 150 into the flow splitter 601A. The flow splitter 601A divides the incoming sample mixture between the outgoing channels 603A and 603B. This allows respective subsample mixtures to be introduced into separate cell chambers, 602A and 602B.

In some embodiments, the operation of all cell chambers 602A and 602B is identical, therefore the letters are withheld from the numerals when making general description of the component. It should be noted that throughout this document, when letters are withheld from a reference number, the discussion generally applies to any specifically lettered version of that component. The microfluidic output valve 606 downstream from each of the cell chambers 602 allows the subsample mixtures to be held in the cell chambers. The output valve 606 controls the flow of the subsample mixtures out of the cell chamber 602 into the output channel 608. Depending on the embodiment, the valve 606 is either a sieve valve such that when it is closed it allows the flow of buffer 158 through, but not the sample cells 154; or it can be a valve which does not allow any flow to escape when it is closed. When the valve is open, it allows the flow of the cells out of the chamber into said output channel 608 as is illustrated in FIG. 8. The cell chamber testing element 604 (illustrated as a sample channel in this embodiment) is attached in such a way to allow a portion of the buffer 158 to be removed from the sample mixture for an assay technique. In this embodiment, sample channels from each of said occupied cell chambers 602 are used to extract samples of the buffer and secreted molecules, cell progeny or other items 158 of each of the subsamples by flowing buffer through the ingoing channels and out through the sample channels.

Each of the samples in the sample channels are assayed for the presence of target cells of interest 406. The assay can be conducted by: detecting a target molecule being produced by the cell with techniques such as HPLC-MS, NMR, antibodies or other methods; lysing the progeny of the current population of cells and examining their cytoplasm with techniques such as HPLC-MS, NMR, antibodies or other methods; detecting a target signal being produced by the population with a microscope, ammeter, or other device; or other methods. If a target cell is not present in a population the population will be discarded/removed from the process 408 by not opening the valve to flow the cells through. If said target cells are present in a plurality and are detected by said assay, the valve is opened to the chamber corresponding to the positive sample, and the process starts again with splitting the cells into multiple population sub-subsample mixtures using the flow splitter 601S. This process is continued until an isolation criterion is met. In some embodiments, the process continues until only isolated single cells with positive assays remain. These cells are then collected from the output to the microfluidic device. Thus, the cells are identified in logarithmic time relative to the total number of cells in the starting population, where the base of the logarithm is the number of subpopulations the population is split into.

Thus, some embodiments provide a microfluidic apparatus having a branched or tree structure for the isolation of a target cell from a plurality of sample cells. The apparatus comprises a first cell chamber configured to hold a sample mixture including one or more sample cells including at least one target cell. The first cell chamber includes a first cell chamber testing element configured for use in testing the sample mixture and a first cell chamber output valve configured to control flow of the sample cells of the sample mixture out of the first cell chamber when the sample mixture is larger than a desired size. A first cell chamber output channel is coupled to the first cell chamber output valve and includes a first flow splitter for dividing the sample mixture into at least two subsample mixtures each comprising one or more sample cells. The apparatus further comprises a plurality of second cell chambers. Each second cell chamber of the plurality of second cell chambers is configured to hold a respective subsample mixture. Each respective second cell chamber includes a second cell chamber testing element configured for use in testing the subsample mixture. In some embodiments, the testing element includes a second cell chamber testing channel configured to allow removal of a portion of the respective subsample mixture from the second cell chamber while retaining the one or more sample cells of the respective subsample mixture. The apparatus further comprises a second cell chamber output valve configured to control flow of the one or more cells of the respective subsample mixture out of the second cell chamber. It also includes a second cell chamber output channel coupled to the second cell chamber output valve with a second flow splitter for dividing the subsample mixture into at least two sub-subsample mixtures each comprising one or more sample cells. The branched apparatus also includes a plurality of third cell chambers. Each respective third cell chamber is configured to hold a respective sub-subsample mixture. Each third cell chamber further including a third cell chamber testing element configured for use in testing the sub-subsample mixture and a third cell chamber output valve configured to control flow of the one or more cells of the respective sub-subsample mixture out of the third cell chamber.

The cell chamber output valves of the microfluidic apparatus describe above are configured to allow their respective mixture to pass to out of their respective cell chamber when their respective mixture contains a target cell. Furthermore, the first, second, and third cell chamber output valves of the branched microfluidic apparatus are configured to retain their respective mixture in their respective cell chamber when the target cell is not present in the respective mixture.

### III d) Microfluidic Apparatus Having a Looped Structure

A microfluidic apparatus having a looped structure 90 used to separate a cell secreting a molecule of interest from a population of cells (e.g., a plurality of cells) is illustrated in the schematic in FIG. 9. The device 90 consists of one or more input channel(s) 900. In some embodiments, the input channel 900 is a physical channel (i.e., a typical tube suitable for this apparatus), while in other embodiments the input channel is a cell chamber, and in still other embodiments it is an input receiving means such as an aperture or hole for receiving a sample mixture. In some embodiments, the input channel 900 is intersected by an input valve 902. In some embodiments, the input channel 900 connects to a first cell chamber (also called a backsorting chamber) 908. In some embodiments, the backsorting chamber 908 is coupled to the input channel 900, one or more ingoing back sorted channels 906A and 906B, and one outgoing channel 907. In other embodiments, a backsorting chamber 908 is not used, and the input channel 900 is coupled directly to one or more ingoing back sorted channels 906, and the outgoing channel 907.

In some embodiments, the backsorting input valves 904A and 904B each intersect an ingoing backsorting channel, 906A and 906B respectively. In some embodiments, the outgoing channel 907 intersects with output valve 910. In some embodiments, the outgoing channel 907 is then connected with the secondary input channel 912. The secondary input channel 912 intersects with its own secondary input valve 914. In other embodiments, the secondary input channel 912 (and valve 914), intersects the input channel 900. The outgoing channel 907 is coupled to flow splitter 916. The flow splitter 916 consists of one input (i.e., the outgoing channel 907) and at least two outgoing channels 911A and 911B. Each of the outgoing channels of the flow splitter 916 then connects to second cell chambers 920. In this embodiment, each of the outgoing channels 911A and 911B of the flow splitter 916 then connects to second cell chambers 920A or 920B. In other embodiments, more than two second cell chambers 920 are present. In some embodiments, three, five, ten, or twenty second cell chambers 920 are present. In some embodiments, any number of secondary cell chambers 920 under one hundred are present. In some embodiments, more than one hundred secondary cell chambers 920 are present. These second cell chambers 920A or 920B each have one ingoing channel (911A or 911B respectively), and two outputs 918A and 921A or 918B and 921B respectively. The second cell chambers 920A and 920B are configured to hold a respective subsample mixture and assay the mixture as described with reference to FIGS. 7 and 8. As such, in some embodiments, the testing elements 918A and 918B include a testing channel 702, and optionally include a flow grating 704 and/or a testing apparatus 708 (as shown and described with reference to FIG. 7), and testing elements 918A and 918B are configured to test the sample mixture for the presence of one or more target molecules.

In some embodiments, the output channels 921A or 921B each connect to two channels. In the two channel embodiment, the first channel of each of the outputs 921A or 921B leads to a discard channel 926 and is intersected by discard valves 924A or 924B respectively. Furthermore, in the two channel embodiment, the second channel of each of the output channels 921A or 921B is intersected by backsorting valves 922A or 922B respectively and then to the backsorting channel 906A or 906B. In some embodiments, the respective backsorting channels 906A or 906B then continues into the (optional) backsorting chamber 908. As will be explained in more detail in section IIIe, a subsample mixture is selectively flowed into either a backsorting channel 906 or an output channel 921 using a selectively opened and closed backsorting valve 922 and discard valve 924, depending on whether it is being reflowed or discarded. In some embodiments, the sample mixture in the backsorting chamber 908 can be held in the chamber for an appropriate period of time for production of a target molecule to occur. In some embodiments, an appropriate period of time for this process to occur is from between several minutes to several days. In some embodiments, an optional heating plate or optional cooling plate is configured so that the temperature in the backsorting chamber 908 is raised or lowered, thus increasing or reducing the appropriate period of time for target molecule production. In some embodiments, the sample mixture in the backsorting chamber 908 can be held in the chamber for an appropriate period of time for one or more cycles of cell division in the cell population in the sample mixture to occur. In some embodiments, an appropriate period of time for this process to occur is from between several minutes to several days. In some embodiments, an optional heating plate or optional cooling plate is configured so that the temperature in the backsorting chamber 908 is raised or lowered, thus increasing or reducing the appropriate period of time for cell division to occur.

In some embodiments, the output channels 921A or 921B merge together to form a single output channel and then lead to a single discard channel 926 and to a single backsorting channel (not shown). In some embodiments, a selection valve is coupled to the second cell output channels 921A and 921B, and the selection valve controls the introduction of the subsample mixture either into the discard channel 926 (when a discard criterion is met) or the backsorting channel 906 (when a backsorting criterion is met). In other embodiments, a single discard valve 924A is coupled to the merged discard channel, and is configured to control the introduction of the subsample mixture into the discard channel when a discard criterion is met. Furthermore, a single backsorting valve 922A is coupled to the merged discard channel, and is configured to control the introduction of a subsample mixture into the backsorting channel 906A when a retention criterion is met. It is noted that when only a single discard channel 926 and a single backsorting channel 906A are utilized, each second cell chamber is emptied serially, whereas when each second cell chamber has its own discard channel and backsorting channel the second cell chambers can be emptied in parallel (i.e., at the same time).

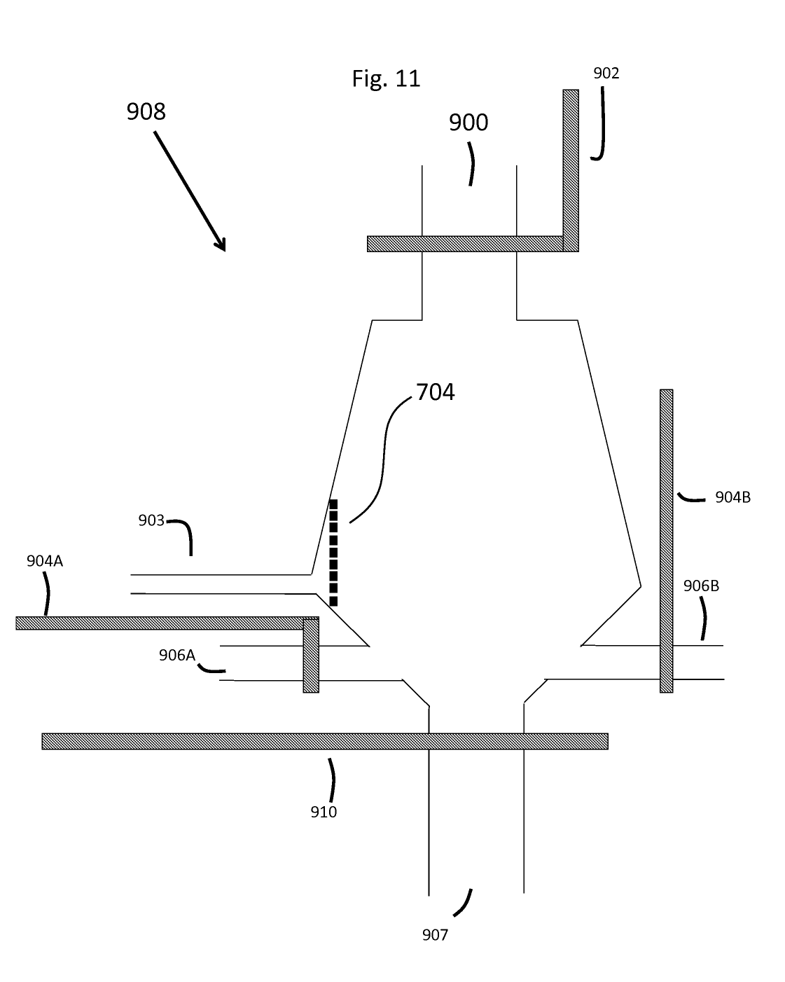

Another microfluidic apparatus having a looped structure 90 used to separate a cell secreting a molecule of interest from a population of cells (e.g., a plurality of cells) is illustrated in the schematic in FIG. 10. In FIG. 10 the backsorting chamber 908 further includes an additional filtered outlet 903. In some embodiments, the additional filtered outlet 903 is a testing element which is utilized to assay a sample mixture in the backsorting chamber. In other embodiments, the additional filtered outlet 903 is not used for testing. Instead, the filtered outlet 903 allows new material to be introduced into the backsorting chamber as is explained below with reference to FIG. 11.

FIG. 11 is a schematic illustrating one embodiment of a microfluidic cell backsorting chamber 908 with an additional filtered outlet 903. The filtered outlet includes a flow grating 704 allow a portion of the buffer 158 to be removed from the sample mixture 150, while retaining the plurality of sample cells 154 in the backsorting chamber 908. Details regarding the types of mechanisms and materials of the flow grating 704 are described with reference to FIG. 7. In most embodiments, the purpose of the flow grating is to allow excess buffer to be removed the apparatus when new buffer is introduced. For example, when a sample mixture is first introduced into the looped microfluidic apparatus, the backsorting chamber may be initially filled with only buffer. Then valve 902 is opened, while valves 904A, 904B and 910 are closed. The sample mixture comprising one or more sample cells including at least one target cell is introduced into backsorting chamber 908, and thus in order to maintain equilibrium at least a portion of excess buffer flows out of filtered outlet 903. Similarly, for example, in order to reflow a subsample mixture out of a secondary chamber 920A and back into the backchamber 908, valves 902, 904B, 910, and 924A are closed while valves 922A, 904A, and 914 are opened. Buffer is flowed in through secondary input channel 912 thus pushing the subsample mixture through the backsorting channel 906A and into the backsorting chamber 908, thus in order to maintain equilibrium at least a portion of excess buffer flows out of filtered outlet 903. It is noted that in the embodiment shown in FIG. 9, instead of using the filtered outlet 903 of FIG. 10 to maintain fluidic equilibrium, input valve 902 is a sieve valve which allows excess buffer to flow out of the looped microfluidic apparatus.

It is noted, that in some implementations, the microfluidic apparatus having a looped structure 90 (e.g. those shown in FIGS. 9 and 10) is mounted on a heating plate. In other implementations, the microfluidic apparatus is mounted on a cooling plate. This optional mounting on a heating or cooling plate allows the microfluidic apparatus to be heated or cooled respectively during the cycle/separation process. In some embodiments, the temperature provided by the heating or cooling plate to the microfluidic apparatus can be any biologically viable temperature. In some embodiments, cooling the microfluidic apparatus can stop or retard cell division activity which, in some implementations, is beneficial while an assay technique is being performed. In some embodiments, heating the microfluidic apparatus can encourage cell division activity which, in some implementations, is beneficial for generating relevant diversity in a population of cells when performing directed evolution. In some embodiments, the microfluidic apparatus is mounted to a plate with both heating and cooling capabilities, which are used to selectively heat and cool the plate during various portions of the cycle in accordance with whether cell division activity is to be encouraged or discouraged.

### III e) Operation of a Microfluidic Apparatus Having a Looped Structure

The operation of a microfluidic apparatus having a looped structure, for example that of FIG. 9, is now provided. A sample mixture is introduced into the backsorting cell chamber 908 (also sometimes referred to as a first cell chamber) through the input channel 900 with the input valve 902 (completely or partially) open. In some embodiments, no backsorting cell chamber 908 is present, and as such, the input channel 900 is connected to the flow splitter 916, and thus the sample mixture flows from the input channel to the flow splitter 916. In the embodiment illustrated in FIG. 9, with the backsorting input valves 904A and 904B both closed and the outgoing channel valve 910 open, the sample mixture is introduced into the flow splitter 916. The flow splitter 916 divides the sample mixture into a plurality of subsample mixtures. In the embodiment illustrated in FIG. 9, the flow splitter 916 divides the sample mixture into a subsample mixture which enters cell chamber 920A and a subsample mixture which enters cell chamber 920B, via outgoing channels 911A and 911B respectively. In the embodiment illustrated in FIG. 9, with all four valves 922A, 922B, 924A, and 924B closed, buffer is introduced into the input channel 900 and flowed out output channels of testing elements 918A and 918B. Using the mixtures flowed out of the output channels of testing elements 918A and 918B, the subsample mixtures in the respective cell chambers 920A or 920B are tested as described herein, such as in section IIIb (e.g. the buffer mixtures are assayed to determines the presence/absence or quantity of target molecule(s) in the buffer.) Excess buffer, if any, is optionally flowed out the output channels of testing elements 918A and 918B. (It is noted, that, given a continuous rate of molecule production, controlling the flow rate can control the final concentration of the molecule in a solution). If the subsample mixture in the respective cell chamber 920A or 920B is determined not to have a target cell, then a discard criterion has been met, and the subsample mixture is discarded through a discard channel 926. In the embodiment illustrated in FIG. 9, the corresponding discard valve, 924A or 924B is opened to remove the subsample mixture from the system (e.g. the from the apparatus) through the discard channel 926. If the subsample mixture is determined to have a target cell, then a retention criterion has been met and the subsample mixture is retained for further iterative testing. In the embodiment illustrated in FIG. 9, when a retention criterion is met, the corresponding backsorting valve 922A or 922B, and corresponding backsorting input valve 904A or 904B are opened and outgoing channel valve 910 is closed such that the subsample mixture is introduced into the backsorting channel 906A or 906B. It is noted that in some embodiments, a single valve is used in place of both the backsorting valve 922A and the backsorting input valve 904A. It is also noted that in some embodiments a single backsorting channel is used by each secondary cell chamber 920A or 920B. Buffer is introduced in through the secondary input channel 912, and out through the closed sieve valve 902 The retained submixture is re-introduced into the backsorting cell chamber 908 through corresponding backsorting channel 906A or 906B. This operation, process, method, or iteration is continued until an isolation criterion is met. In some embodiments, an isolation criterion is met when a target cell is present in a submixture and non target cells are not present in the submixture. In other embodiments, the isolation criterion is met when a target cell is present and the subsample mixture is not larger than a desired size (as described in this document).

Thus, in some embodiments, a looped microfluidic apparatus for the isolation of a target cell from a plurality of sample cells is provided. The apparatus comprises a first cell input element (such as a first cell input channel) configured to receive a sample mixture comprising one or more sample cells including at least one target cell. It also comprises a flow splitter configured to divide the sample mixture into at least two subsample mixtures each comprising one or more sample cells. The apparatus further comprises a plurality of second cell chambers. A respective second cell chamber of the plurality of second cell chambers is configured to hold a respective subsample mixture. A respective second cell chamber includes a second cell chamber testing element configured for use in testing the subsample mixture and a second cell chamber output valve configured to control flow of the one or more sample cells of the respective subsample mixture out of the second cell chamber. The apparatus also comprises a second cell chamber output channel coupled to one or more second cell chamber output valves, a discard channel, and a backsorting channel. It comprises a discard channel configured to receive the one or more sample cells of a respective subsample mixture to flow there through when a discard criterion is met. The backsorting channel is coupled to the flow splitter and is configured receive one or-more sample cells of a respective subsample mixture to be reflowed to the flow splitter for iterative dividing and testing when a retention criterion is met.

In some embodiments, the looped microfluidic apparatus further comprises a first cell chamber (also referred to herein as a backsorting chamber) configured to hold the sample mixture. The first cell chamber is coupled to the first cell input channel, the flow splitter, and the backsorting channel. The first cell chamber includes a first cell chamber testing element configured for use in testing the sample mixture. In some embodiments, the testing element including a testing channel, a flow grating, and a testing apparatus. In other embodiment the testing element does not include a testing apparatus; instead the cell chamber testing element is attached to a testing apparatus which is distinct from the microfluidic apparatus (as described with respect to FIG. 7). It also includes a first cell chamber output valve configured to control the flow of the sample mixture out of the first cell chamber. It further includes a first cell chamber output channel coupled to the first cell chamber output valve and the flow splitter. The one or more sample cells of a respective subsample mixture are reflowed to the first cell chamber for iterative dividing and testing when the retention criterion is met.

In some embodiments, the looped microfluidic apparatus includes a first cell chamber output valve configured to control flow of the sample cells of the sample mixture out of the first cell chamber when the sample mixture is larger than a desired size and is configured to retain the sample mixture in the first cell chamber when the sample mixture is not larger than a desired size.

In some embodiments, the first cell chamber testing element of the looped microfluidic apparatus is configured to allow removal of a portion of the sample mixture from the first cell chamber while retaining the one or more sample cells of the sample mixture in the first cell chamber.

In some embodiments, the second cell chamber testing element of the looped microfluidic apparatus is configured to allow removal of a portion of the respective subsample mixture from the second cell chamber while retaining the one or more sample cells of the respective subsample mixture in the second cell chamber.

In some embodiments, the looped microfluidic apparatus includes a selection valve coupled to the second cell chamber output channel, the discard channel, and the backsorting channel. The selection valve is configured to control flow of the one or more sample cells of a respective subsample mixture into the discard channel when the discard criterion is met. The selection valve is further configured to control flow of the one or more sample cells of a respective subsample mixture into the backsorting channel and the flow splitter for iterative dividing and testing when the retention criterion is met.

In some embodiments, the looped microfluidic apparatus includes a discard valve coupled to the discard channel. The discard valve is configured to control flow of the one or more sample cells of a respective subsample mixture into the discard channel when the discard criterion is met. The looped microfluidic apparatus also includes a backsorting valve coupled to the backsorting channel. The backsorting valve is configured to control flow of the one or more sample cells of a respective subsample mixture into the backsorting channel and flow splitter for iterative dividing and testing when the retention criterion is met.

In some embodiments, the discard criterion is met when one of the second cell chambers distinct from the respective second cell chamber contains a target cell. It is noted, that this occurs when the target cell is not present in the respective subsample mixture or when both subsample mixtures have the target cell and so one of them is still discarded. In some embodiments, the discarding is random. In other embodiments, the better performing subsample is retained while the other is discarded. In some embodiments, a subsample is considered better performing when more target cells or more target molecules are present. In embodiments in which the subsamples were not equal in amount of sample cells, better performing means that a larger percentage of target molecules are present. In some embodiments, a better performing subsample is one in which the target cells appear to be most efficient, e.g. efficiency measured based on quantity or quality of target molecules produced. In some embodiments, the discard criterion is met when the target cell is not present in the respective subsample mixture.

In some embodiments, the retention criterion is met when the respective subsample mixture contains a target cell and the respective subsample mixture is larger than a desired size. Desired size is defined herein a number of remaining sample cells. In some embodiments the desired size is 1 sample cell, which is the target cell. It is noted that desired size may not relate to a larger or smaller total volume of sample, because in some embodiments as the samples are divided and re-tested such that the number of sample cells decreases, more buffer solution is added to the sample. As such each subsample could have a similar volume to its parent.

In some embodiments of the output valve is configured to retain the respective subsample mixture when an isolation criterion is met. In some embodiments, the isolation criterion is met when the respective subsample mixture contains a target cell and the respective subsample mixture is not larger than a desired size. In some embodiments, the desired size is one target cell.

In some embodiments, the looped microfluidic apparatus also includes an additional backsorting channel coupled the flow splitter and one of the second cell chambers (a cell chamber distinct from the respective second cell chamber and configured to hold an additional subsample mixture distinct from the respective subsample mixture). The additional backsorting channel is configured receive one or more sample cells of the additional subsample mixture to be reflowed to the flow splitter for iterative dividing and testing when the retention criterion is met.

In some embodiments, the chamber testing element is configured to test for the presence of the at least one target cell.

Some embodiments include a combination of any or all of the components (or elements) described in any of the above paragraphs.

### III f) Method of Making the Microfluidic Apparatus

In some embodiments, the apparatuses described herein are made of different layers of PDMS (polydimethylsiloxane) with membranes incorporated into it as filters. In some embodiments, an apparatus is composed of two layers containing different types of channels: fluidic channels and actuation channels. In some embodiments, the fluidic channels have a rounded cross section. In some embodiments, the actuation channels have a square cross-section. The fluids of interest (such as the sample mixtures as well as additional buffer and a buffer containing a target molecule) pass through the fluidic channels while the actuation channels are used to control the opening and closing of the valves in the fluidic channels. As such, the flow of samples and subsamples through the fluidic channels are controlled using the actuation channels. It is noted, that the fluidic channels are the channels illustrated in the figures of this document. The actuation channels are not illustrated. The designs of the actuation channels can be suitable design which controls the opening and closing of the valves in the fluidic channels. Furthermore, it is understood that any suitable mechanism could be used instead of the actuation channels to open and shut valves (for example a manual or electronic switch). Therefore, unless otherwise noted in this application, when a channel is described, it is a fluidic channel, not an actuation channel.

In some embodiments, the fluidic and actuation channel layers are sealed into a closed device (i.e., the apparatus's bottom layer and top layers are the same material) against glass or another layer of PDMS as described below.

In order to be able to inject and collect samples (sample mixtures) from the microfluidic apparatus, holes are created (e.g., with a syringe) into the PDMS, unsealing the corresponding inlets and outlets of the fluidic channels. For actuation channels, one hole is created, allowing high pressure to expand the channel, blocking the channels in the other layers and closing the valve(s). The holes are later connected to a syringe for injecting samples into the fluidic channels or opening/closing the valves via the actuation channels.

In some embodiments, a microfluidic apparatus, is manufactured as follows.

In some embodiments, to make a PDMS layer, first a positive mold of plastic with the apparatus design is created. Then PDMS is cast onto it, obtaining the negative pattern of the mask into the PDMS layer.

In some embodiments, making a round channel is done as follows. A positive mold is designed in AutoCad as a series of lines. Then, in some embodiments, a desktop laser printer (such as the Hewlett Packard LaserJet 1010) is used to print the lines (as explained in Grimmes et. al., Lab on a Chip, 2007). The designs are printed into a heat-shrink Polyolefin plastic (e.g., Cryovac D-955, 15 um of thickness, Sealed Air). To avoid shrinkage of the plastic inside the laser printer, this plastic is temporarily attached (e.g., taped) to a hard cover (e.g., a polystyrene sheet). The printed plastic is then removed from the cover and heated at an appropriate temperature, for example between about 80° C. and 200° C. or about 100° C. and 150° C. using an oven with temperature control (e.g. Artificial Intelligence Industrial Controller, Shanghai Heming Electric Co.). In some embodiments, in order to have a uniform shrinkage this heading is performed in water (such as glass petri dish filled with distilled water covering the printed plastic). The printed plastic is headed for a sufficient amount of time, for example between about 1 minute and about 2 hours, to cause shrinkage. The consequently shrunk plastic with the correspondingly shrunk design is then used as a mold to cast a layer of PDMS with rounded cross section channels.

In some embodiments, a desktop cutter (e.g., Yuen & Goral, Lab on a Chip, 2009, Silhouette SD) is used to make a square channel as follows. In some embodiments, an off the shelf model is cut by using Silhouette Studio or AutoCad design. The heat-shrink Polyoleofin plastic (e.g., Cryovac D-955, 15 um of thickness, Sealed Air) is cut with the desired design. The heat-shrink plastic now containing the Silhouette Studio or AutoCad design is then removed from the cover and heated at an appropriate temperature, for example between about 80° C. and 200° C. or about 100° C. and 150° C. using an oven with temperature control (e.g. Artificial Intelligence Industrial Controller, Shangai Heming Electric Co.). In some embodiments, in order to have a uniform shrinkage this heading is performed in water (such as glass petri dish filled with distilled water covering the printed plastic). The printed plastic is headed for 10-15 minutes to cause shrinkage. The shrunk plastic with the correspondingly shrunk design is then used as a mold to cast a layer of PDMS with square cross section channels.

In some embodiments, an uncured mixture of PDMS is prepared to cast the PDMS layers. In some embodiments, Sylgard 184 Silicone Elastomer (Dow Corning) is mixed with a curing agent in an approximately 10:1 w/w ratio and centrifuged at approximately 10.000 g for approximately 5 minutes to eliminate bubbles. The previously described Polyolefin shrunk molds are placed against a metal backup tray. Then the uncured PDMS mixture is poured into it. The whole tray is de-gased using a vacuum system for approximately 20 minutes. In some embodiments, the tray is placed in an oven at approximately 60° C. for approximately 20 min to partial curing it or approximately 130° C. for approximately 20 minutes to fully cured. Finally, the cured PDMS is released from the molds, e.g. by pulling carefully from the corner.

In some embodiments, a two layer design is used which integrates a membrane into the apparatus. This design provides improved leakage protection. From the upper layer the fluid flows down to the lower layer, through a fluidic channel passing through the membrane. In some embodiments, to glue both layers with the membrane a mortar is used. For example, a mixture of uncured PDMS/toluene (2:1 w/w) (modified from Chueh et. al, Anal Chem, 2007) is used in some embodiments. The mixture is prepared and centrifuged as described above. Then it is poured onto a clean glass cover slide, thus generating a thin mortar. In some embodiments, the bottom and top PDMS layers are placed in contact with the mortar for no more than 3 seconds. The membrane is aligned onto the bottom layer and then the top layer is placed on top of that applying light pressure. Then this combination is then subjected to an appropriate temperature for an appropriate time to cause curing, such as, for example between about 80° C. and 200° C. for between about 10 minutes and 2 hours or about 90° C. and 130° C. for between about 15 minutes and 45 minutes.

In some embodiments, the microfluidic apparatuses incorporate nitrocelullose 0.2 um pore size membranes, but this system allows the incorporation of other kinds of membrane.

In order to be able to open/close the flow through the channels low-actuation pressure valves are incorporated (e.g., Unger et. al., Science, 2000). For this, a layer of PDMS with the fluidic channels is fused on top of a layer of PDMS with actuation channels, aligning the channels on each layers on a perpendicular fashion. In some embodiments, attaching the layers together is performed as follows: First, the PDMS layers are partially cured as described above. Second, both surfaces are deeply treated with a corona surface treater model BD-20V (e.g., Electro-Techninc Products Inc., Haubert et. al. Lab on a Chip, 2006).

The layer with actuation channels is cast very thin (˜40 um) generating a thin layer of PDMS in between the channels. The layer with fluidic channels is cast thicker (close to 4 mm), for these, different volumes of uncured PDMS are poured on top of it. It is noted, that when fluid is injected through the actuation channel, the pressure inside increases, expanding the thin membrane of flexible PDMS into the channel of the upper layer and blocking the flow through the fluidic layer (as discussed in Studet et. al, J. Appl. Phys. 2004). This configuration is called push-up valve. The apparatus can also integrate push-down valves, where the actuation channel is on top of the fluidic channel opposite to the one here described.

The microfluidic apparatus integrates both filters and valves. In some embodiments of a looped microfluidic apparatus, two chambers are provided for analysis, two membranes and eight valves are used. These components are incorporated into four different manufactured layers. These four manufactured layers from top to bottom of this embodiment include: Layer 1: contains the fluidic channels from the cell input element to the cell chambers. Layer 2: contains four actuation channels to block the fluidic channels from layer 1 in accordance with the methods of use of the microfluidic apparatuses described herein. Layer 3: contains the fluidic channels from the cell chambers to the fluidic discard and when present. Layer 4: contains four actuation channels to block the fluidic channels from layer 3. Layers 2 and 3 are connected using the mortar technique described above. Layer 1 is fused to layers 2/3 using corona treatment described above. Layer 4 is fused to layers 1/2/3 using corona treatment as well. The whole microfluidic apparatus is bonded via the layer 4 with a clean glass cover slip. For this, both surfaces are treated deeply with the corona treater, e.g., for at least 30 seconds. Finally, pressure is applied and the microfluidic apparatus is left undisturbed overnight for assure a good sealing.

### IV EXEMPLARY EMBODIMENTS FOR ISOLATING A TARGET MOLECULE SECRETING CELL FROM A POPULATION OF SAMPLE CELLS

In some embodiments, the microfluidic apparatus is configured to isolate, from a population/plurality of sample cells, a target cell which secretes a target molecule.

In some embodiments, a cell which produces a target molecule is isolated from a population of cells using the microfluidic apparatus described herein, such as in FIG. 6, FIG. 9, or FIG. 10. Cells which can be utilized in the methods and apparatus described herein can include those that one of skill in the art would expect to be effective in producing the target molecule. In some embodiments, the cells have been engineered to produce the target molecule.

In one implementation a yeast cell, Saccharomyces cerevisiae, or a bacterial cell, Escherichia coli, can be used to produce a target molecule, n-butanol. Cells which can be utilized for the production of n-butanol in the methods and apparatuses described herein include those described in Steen, et al., Microbial Cell Factories, 7, 36. (2008), and Connor, et al. Applied Microbiology and Biotechnology, 86(4), 1155-1164 (2010).

In this implementation, the materials used for the flow splitter 916, channels (e.g. any of 900, 906, 907, 911, 912, 918, 921, 926), and cell chambers (e.g. any of 908, 920A, and 920B) are made of any suitable material compatible with cell cultures. In some embodiments, the flow splitter, channels, and cell chambers are made of glass, plastic, or treated PDMS. PDMS can be subjected to treatments known in the art which will retard the absorption of a target molecule, such as a small molecule, on the PDMS. An example of treated PDMS is PDMS treated with TEOS. Additional examples of treated PDMS are referred to herein.

In this implementation, the valves (e.g., any of 902, 904, 910, 914, 922, and 924) used include biocompatible push up or push down valves made from a soft polymer such as PDMS. In some embodiments, these valves are cast onto a mold that contains a microfabricated relief or engraved pattern to produce membrane microvalves. This membrane microvalve enables liquids to be controlled on apparatus. An exemplary basic microfluidic valve is composed of two flexible/elastomer layers such as PDMS. One layer contains channels for flowing liquids (flow layer), and the other layer contains channels that deflect the membrane valve into the flow channel and stop liquid flow when pressurized with air or liquid (control layer).

In some implementations, the flow grating 704 in the sample cell testing element 604 (FIG. 7) is a polycarbonate filter having a preferred pore size of between 0.1 and 0.5 microns (with 0.2 microns preferred). In some embodiments, the grating 704 is a plurality of PDMS pillars with spaces between the pillars ranging from between 0.1 and 0.5 microns (with 0.2 microns preferred).

In some implementations, the flow grating 704 in the sample cell testing element 604 (FIG. 7) is a membrane of polycarbonate, track-etched screen filter, such as Isopore filters produced by EMD Millipore 290 Concord Road, Billerica, Mass. 01821. In some embodiments, the membrane is composed of polycarbonate film, which has a smooth, glass-like surface for clearer sample observation. In some embodiments, the membranes are non-hygroscopic, which permits rapid drying and reduced sample analysis time.

In some embodiments of a push up valve, one or more control lines in the control layer pass under the flow channels in the flow layer. Pneumatic pressurization of the control line causes a membrane to deflect up into the flow structure, sealing the channel.

In some embodiments of a push down valve, one or more control lines in the control layer pass over the flow channels in the flow layer. Pneumatic/hydraulic pressure in the control lines flattens the membrane valve downwards to create a seal.

A population of sample cells containing a single target cell producing a target molecule, such as an-butanol, is discussed herein. Sample cell populations containing more than one target molecule producing cell can be diluted with serial dilutions to the level of having close to one target molecule producing cell. The splitting and sorting procedure described herein can be used with more than one target molecule producing cell to get to the level of than one target molecule producing cell by discarding all but one assay positive population. In some embodiments, a sample mixture containing a population containing a single n-butanol producing cell, such as those referenced herein, and many non-producing or minimally-producing cells can be introduced into the backsorting cell chamber 908 through the input channel 900 with the input valve 902 open and other valves closed. Excess buffer can be flowed out the filtered output channel 903, the filter 704 holds the cells in the chamber while allowing the excess buffer to pass out of the device. With the backsorting input valves 904A and 904B both closed and the outgoing channel valve 910 open, the sample mixture can be introduced into the flow splitter 916. The flow splitter 916 divides the sample mixture into respective subsample mixtures between the cell chambers 920A and 920B.

The S. cerevisiae can be held in the cell chambers 920A and 920B for between several minutes and several hours at appropriate conditions for n-butanol production from the single n-butanol producing cell. In some embodiments, the appropriate conditions include (5 minutes to 6 hours at temperatures of 5-30 degrees ° C.). After between several minutes and several hours (e.g. 5 mins to 6 hours) of production, a testable quantity of n-butanol is likely to have been formed. With all four valves 922A, 922B, 924A, and 924B closed, appropriate buffer can be introduced in through the input channel 900 and samples can be taken, through the output channels of testing elements 918A and 918B, the cells being held in the chamber with the respective filters on the sample lines. HPLC-IR can be used to detect the presence of n-butanol in the samples of buffer. If the assay is negative then the subsample mixture does not contain a target cell. If the subsample mixture is determined not to have the target cells, the corresponding discard valve, 924A or 924B is opened to remove the subsample mixture from the system through the output channel 926. If the subsample mixture is determined to have a target cell producing a target molecule (i.e. n-butanol), the backsorting valve 922A or 922B, corresponding to said population, and valves 904A or 904B corresponding to said population are opened and output valve 910 is closed. Buffer can be flowed in through the secondary input channel 912, and out through the closed sieve valve 902 or thorough filtered sample line 903. The selected subsample mixture is flowed back into the backsorting cell chamber 908 through corresponding backsorting channel 906A or 906B. This process is continued until an isolation criterion is met. An isolation criterion is the criteria by which a cell is considered sorted. In some embodiments this is a single cell. In other embodiments it is a number of cells that is amenable to creating colonies in a plate based assay. In some embodiments, the process continues until only isolated single cells with positive assays remain.

In some embodiments, to engineer a line of cells secreting a specific protein or enzyme can involve two steps. The first step is generating enough genetic diversity to be likely to create a cell producing the target molecule, such as a protein or enzyme. The second step is isolating the cell that produces the target molecule, such as a protein or enzyme. Diversity can be generated with a method described herein as well as many protein specific methods including but not limited to Structure-Based Combinatorial Protein Engineering (SCOPE) O'Maille, P. Journal of Molecular Biology, 321(4), 677-691 (2002); FIND Technology, U.S. Pat. No. 7,262,012; or metagenomic methods, Sommer, et al., Molecular Systems Biology, 6, 1-7 (2010).

S. cerevisiae and E. coli have both been used in the past to produce or secrete human and other antibodies Boder, et al. Nature Biotechnology, 15(6), 553-557 (1997). Recombinant DNA methods of various kinds have been used to create diversity in these antibody producing yeast and bacteria. Using such a system it is possible to create a library of cells secreting a diverse array of antibodies. With sufficient diversity it is possible to create a single cell in the population that produces an antibody to a specific epitope—such as α-D-N-acetylgalactosamine—an epitope present in the worst breast cancers Lescar, et al., Glycobiology, 17(10), 1077-1083 (2007).

A sample mixture containing a plurality of yeast, bacterial or other cells producing different types of antibodies can be placed within the microfluidic apparatus. The sample mixture can be divided into two or more subsample mixtures in different cell chambers. Each subsample can be allowed to produce antibodies into the buffer. The buffer can be then sampled from the testing element attached to the cell chamber. For each subsample mixture, the buffer can be then washed over cancer cells expressing the desired α-D-N-acetylgalactosamine epitope. Unbound antibodies can be washed away from the cancer cells. A fluorescently labeled secondary antibody can be then used to fluorescently label the antibodies, if present, to determine if there are antibodies attached to the cancer cells. If the secondary antibodies attach, and a fluorescent signal is produced by the buffer from a specific subsample mixture, the cells in the corresponding cell chamber can be preserved and the subsample mixtures in the other cell chambers can be discarded. The cell chamber with the preserved subsample mixture can be then opened and the preserved subsample mixture can be reflowed back to be resplit. The process can be repeated until a small enough population of antibody expressing yeast or bacterial cells to test with other methods is achieved. Thus, the cell producing the antibody that bound to the α-D-N-acetylgalactosamine epitope is isolated.

### V. CONCLUSION

Thus the reader can see that at least one embodiment is much faster in isolating or sorting rare physical items than the prior art. Further, at least one embodiment allows more sensitive and versatile detection of the properties of the rare items. While the above description contains specificities for the purpose of illustration, these should not be construed as limitations on the scope, but rather as an exemplification of several embodiments thereof.

It is noted, that for the various microfluidic embodiments described herein, the mechanisms can also be embodied in glass, steel, other metals, ceramic or plastic or other materials with or without various coatings. The size and shape of the flow splitters, the cell chambers of the microfluidic devices and the sample channels can also be embodied with different shapes. Further, the sample channels can be replaced with outgoing flow from the output channels of the microfluidic device for an alternative embodiment. The devices can be embodied with more than two outputs for each flow splitter. As well, multiple microfluidic devices can be used simultaneously in parallel or in series. For the lab protocol embodiment, other methods of separating cells such as with a filter or a microfluidic device can be used. Accordingly, the scope should be determined not by the embodiment(s) illustrated, but by the appended claims and their legal equivalents.

The foregoing description, for purpose of explanation, has been described with reference to specific embodiments. However, the illustrative discussions above are not intended to be exhaustive or to limit the invention to the precise forms disclosed. Some embodiments include a combination of any or all of the components, elements, or methods herein. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

It is understood that the examples, embodiments, and implementations described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

1. A looped microfluidic apparatus for the isolation of a target cell from a plurality of sample cells comprising:
a first cell input element configured to receive a sample mixture comprising one or more sample cells including at least one target cell;
a flow splitter configured to divide the sample mixture into at least two subsample mixtures each comprising one or more sample cells;
a plurality of second cell chambers, wherein a respective second cell chamber of the plurality of second cell chambers is configured to hold a respective subsample mixture, the respective second cell chamber further including:
a second cell chamber testing element configured for use in testing the subsample mixture; and
a second cell chamber output valve configured to control flow of the respective subsample mixture out of the second cell chamber;
a discard channel, configured to receive the respective subsample mixture to flow there through; and
a backsorting channel coupled to the flow splitter and configured to receive the respective subsample mixture to be reflowed to the flow splitter.

2. The looped microfluidic apparatus of claim 1, wherein the discard channel is configured to receive the respective subsample mixture to flow there through when a discard criterion is met.

3. The looped microfluidic apparatus of claim 1, wherein the backsorting channel is configured for iterative dividing and testing when a retention criterion is met.

4. The looped microfluidic apparatus of claim 1, further comprising a second cell chamber output channel coupled to one or more second cell chamber output valves, the discard channel, and the backsorting channel.

5. The looped microfluidic apparatus of claim 1, further comprising:
a first cell chamber configured to hold the sample mixture, coupled to the first cell input channel, the flow splitter, and the backsorting channel, the first cell chamber further including:
a first cell chamber output valve configured to control the flow of the sample mixture out of the first cell chamber;
a first cell chamber output channel coupled to the first cell chamber output valve and the flow splitter;
wherein the respective subsample mixture is introduced into the first cell chamber for iterative dividing and testing when the retention criterion is met.

6. The looped microfluidic apparatus of claim 5, wherein the first cell chamber output valve configured to control flow of the sample mixture out of the first cell chamber when the sample mixture is larger than a desired size and is configured to retain the sample mixture in the first cell chamber when the sample mixture is not larger than a desired size.

7. The looped microfluidic apparatus of claim 1, wherein the second cell chamber testing element is configured to allow removal of a portion of the respective subsample mixture from the second cell chamber while retaining the sample cells of the respective subsample mixture in the second cell chamber.

8. The looped microfluidic apparatus of claim 4, further comprising:
a selection valve coupled to the second cell chamber output channel, the discard channel, and the backsorting channel, wherein the selection valve is configured to:
control flow of a respective subsample mixture into the discard channel when the discard criterion is met; and
control flow of a respective subsample mixture into the backsorting channel and the flow splitter for iterative dividing and testing when the retention criterion is met.

9. The looped microfluidic apparatus of claim 1, further comprising:
a discard valve coupled to the discard channel, wherein the discard valve is configured to control flow of the respective subsample mixture into the discard channel when a discard criterion is met;
a backsorting valve coupled to the backsorting channel, wherein the backsorting valve is configured to control flow of the respective subsample mixture into the backsorting channel and flow splitter for iterative dividing and testing when a retention criterion is met.

10. The looped microfluidic apparatus of claim 2, wherein the discard criterion is met when one of the second cell chambers distinct from the respective second cell chamber contains a target cell.

11. The looped microfluidic apparatus of claim 2, wherein the discard criterion is met when the target cell is not present in the respective subsample mixture.

12. The looped microfluidic apparatus of claim 3, wherein the retention criterion is met when the respective subsample mixture contains a target cell and the respective subsample mixture is larger than a desired size.

13. The looped microfluidic apparatus of claim 1, wherein the respective second cell chamber output valve is configured to retain the respective subsample mixture when an isolation criterion is met.

14. The looped microfluidic apparatus of claim 13, wherein the isolation criterion is met when the respective subsample mixture contains a target cell and the respective subsample mixture is not larger than a desired size.

15. The looped microfluidic apparatus of claim 14, wherein the desired size is one target cell.

16. The looped microfluidic apparatus of claim 1, further comprising:
an additional backsorting channel coupled the flow splitter and one of the second cell chambers distinct from the respective second cell chamber configured to hold an additional subsample mixture distinct from the respective subsample mixture,
wherein the additional backsorting channel is configured to receive the additional subsample mixture to be reflowed to the flow splitter for iterative dividing and testing when the retention criterion is met.

17. The looped microfluidic apparatus of claim 1, wherein the second cell chamber testing element is configured to test for the presence of the a target cell.

18. A branched microfluidic apparatus for the isolation of a target cell from a plurality of sample cells comprising:
a first cell chamber configured to hold a sample mixture including one or more sample cells including at least one target cell, the first cell chamber further including:
a first cell chamber testing element configured for use in testing the sample mixture; and
a first cell chamber output valve configured to control flow of the sample mixture out of the first cell chamber;
a first cell chamber output channel coupled to the first cell chamber output valve and including a first flow splitter for dividing the sample mixture into at least two subsample mixtures each comprising one or more sample cells;
a plurality of second cell chambers, wherein a respective second cell chamber of the plurality of second cell chambers is configured to hold a respective subsample mixture, the respective second cell chamber further including:
a second cell chamber testing element configured for use in testing the subsample mixture; and
a second cell chamber output valve configured to control flow of the respective subsample mixture out of the second cell chamber;
a second cell chamber output channel coupled to the second cell chamber output valve and including a second flow splitter for dividing the subsample mixture into at least two sub-subsample mixtures each comprising one or more sample cells;
a plurality of third cell chambers, wherein a respective third cell chamber of the plurality of third cell chambers is configured to hold a respective sub-subsample mixture, the respective third cell chamber further including:
a third cell chamber testing element configured for use in testing the sub-subsample mixture; and
a third cell chamber output valve configured to control flow of the respective sub-subsample mixture out of the third cell chamber.

19. The branched microfluidic apparatus of claim 18, wherein:
the first, second, and third cell chamber output valves are configured to allow their respective mixture to pass to out of their respective cell chamber when their respective mixture contains a target cell; and
wherein the first, second, and third cell chamber output valves are configured to retain their respective mixture in their respective cell chamber when the target cell is not present in the respective mixture.

20. A method of isolating of a target component from a plurality of sample components comprising:
receiving a sample mixture comprising one or more sample components including at least one target component;
dividing the sample components of the sample mixture into at least two subsample mixtures each comprising one or more sample components;
testing the at least two subsample mixtures for the presence of the a target component;
discarding a respective subsample mixture of the at least two subsample mixtures when a discard criterion is met; and
retaining a respective subsample mixture of the at least two subsample mixtures when a retention criterion is met and iteratively performing the dividing, testing, discarding, and retaining until an isolation criterion is met.

21. The method of claim 20 comprising isolating of a target cell from a plurality of sample cells:
wherein the one or more sample components are one or more sample cells, and the target component is a target cell;
wherein the at least two subsample mixtures each comprising one or more sample cells; and
wherein the testing comprises assaying the at least two subsample mixtures for the presence of the target cell.

22. The method of claim 20 wherein the assaying includes one or more of the following techniques: detecting a target molecule being produced by the target cell; lysing the progeny of the respective subsample mixture and examining their cytoplasm; and detecting a target signal being produced by the respective subsample mixture.

23. The method of claim 20 comprising identifying one or more target chemicals with one or more properties of interest from a set of separate chemicals:
wherein the one or more sample components are one or more sample chemicals, and the target component is a target chemical;
wherein the at least two subsample mixtures each comprising one or more sample chemicals; and
wherein the testing comprises testing the at least two subsample mixtures for the presence of the target chemical by testing for the one or more properties of interest.

24. The method of claim 20 comprising identifying one or more physical items of interest from a set of separate physical items:
wherein the one or more sample components are one or more sample physical items, and the target component is a target physical item;
wherein the at least two subsample mixtures each comprising one or more sample physical items; and
wherein the testing comprises testing the at least two subsample mixtures for the presence of the target physical item.
